(19) United States
(12) Patent Application Publication
(10) Pub. No.: US 2024/0333996 A1
(43) Pub. Date: Oct. 3, 2024

(54) Devices for Media Handoff

(71) Applicant: Google LLC, Mountain View, CA (US)

(72) Inventors: Jian Wang, Cupertino, CA (US); Nihar Jindal, Palo Alto, CA (US); Meng-hsuan Chung, Los Altos, CA (US); Dennis Yee, San Francisco, CA (US); Arnold Feldman, San Francisco, CA (US)

(21) Appl. No.: 18/570,982

(22) PCT Filed: Jul. 30, 2021
(86) PCT No.: PCT/US2021/043883

§ 371 Date: Dec. 15, 2023

(51) Int. Cl. H04N 21/41; H04N 21/414; H04N 21/43; H04N 21/4363

(52) U.S. Cl. CPC H04N 21/4122; H04N 21/41407; H04N 21/43078; H04N 21/43637

(57) ABSTRACT

Example embodiments relate to devices for media handoff. An example device includes a first transceiver configured to transmit and receive signals to communicate with a second transceiver of a handoff device. The signals are indicative of an orientation and a position of the first transceiver relative to the second transceiver. The device also includes an inertial measurement unit configured to measure changes in angular orientation or position of the device. Additionally, the device includes a memory. The memory stores a first set of instructions. Further, the device includes a processor communicatively coupled to the first transceiver, the inertial measurement unit, and the memory. The processor is configured to execute the first of instructions to cause the handoff device to output a piece of media.

### BACKGROUND

Computing devices (e.g., mobile phones, tablets, and other portable computing devices) are more or less ubiquitous today. Such computing devices may be used to communicate (e.g., using telephone functionality, email functionality, text messaging functionality, or social media functionality), to entertain (e.g., using video or audio streaming services or games), to travel (e.g., using mapping and navigation functionality), etc.

In some cases, such computing devices may be configured to communicate with other devices (e.g., over the public Internet via IEEE 802.11 standards (WIFI), over telecommunications channels, or using short range communications techniques such as BLUETOOTH®). By communicating with other devices, such computing devices may provide instructions, commands, or data to the other devices. For example, a mobile phone may communicate a user command to another device. In some traditional applications, though, such techniques of communication between the mobile phone and other computing devices may be slow, cumbersome, computationally inefficient, or prone to errors.

### SUMMARY

This disclosure relates to devices for media handoff. Example embodiments described herein may include a user device (e.g., a mobile phone) that can be used to handoff media to another device (e.g., a handoff device such as a television, a speaker, etc.). The user device may include a transceiver that can communicate with a transceiver of the handoff device. Based on this communication, the orientation and/or position of the user device relative to the handoff device can be determined over time. Then, based on this determined orientation and/or position, the user device may determine if a media handoff is to be executed (e.g., based on a separation between the transceiver of the user device and the transceiver of the handoff device). If a handoff is to be executed, the user device may transmit a signal to the handoff device to cause the handoff device to output a piece of media and the user device, itself, may stop outputting the piece of media.

In one aspect, a device is provided. The device includes a first transceiver configured to transmit and receive signals to communicate with a second transceiver of a handoff device. The signals are indicative of an orientation and a position of the first transceiver relative to the second transceiver. The device also includes an inertial measurement unit configured to measure changes in angular orientation or position of the device. Additionally, the device includes a memory. The memory stores a first set of instructions. Further, the device includes a processor communicatively coupled to the first transceiver, the inertial measurement unit, and the memory. The processor is configured to execute the first set of instructions to determine a velocity of the device based on the changes in angular orientation or position measured by the inertial measurement unit. The processor is also configured to execute the first set of instructions to determine a transmission frequency based on the velocity of the device. In addition, the processor is configured to execute the first set of instructions to cause the first transceiver to communicate with the second transceiver according to the transmission frequency. Still further, the processor is configured to execute the first set of instructions to determine a separation between the first transceiver and the second transceiver based on signals received by the first transceiver. Additionally, the processor is configured to execute the first set of instructions to compare the separation between the first transceiver and the second transceiver to a first range threshold. Yet further, the processor is configured to execute the first set of instructions to cause the handoff device to output a piece of media when the separation between the first transceiver and the second transceiver is less than the first range threshold.

In another aspect, a system is provided. The system includes a handoff device that includes a second transceiver. The system also includes a user device. The user device includes a first transceiver configured to transmit and receive signals to communicate with the second transceiver. The signals are indicative of an orientation and a position of the first transceiver relative to the second transceiver. The user device also includes an inertial measurement unit configured to measure changes in angular orientation or position of the user device. Additionally, the user device includes a memory. The memory stores a first set of instructions. Further, the user device includes a processor communicatively coupled to the first transceiver, the inertial measurement unit, and the memory. The processor is configured to execute the first set of instructions to determine a velocity of the user device based on the changes in angular orientation or position measured by the inertial measurement unit. The processor is also configured to execute the first set of instructions to determine a transmission frequency based on the velocity of the user device. In addition, the processor is configured to execute the first set of instructions to cause the first transceiver to communicate with the second transceiver according to the transmission frequency. Still further, the processor is configured to execute the first set of instructions to determine a separation between the first transceiver and the second transceiver based on signals received by the first transceiver. Even further, the processor is configured to execute the first set of instructions to compare the separation between the first transceiver and the second transceiver to a first range threshold. Yet further, the processor is configured to execute the first set of instructions to cause the handoff device to output a piece of media when the separation between the first transceiver and the second transceiver is less than the first range threshold.

In an additional aspect, a method is provided. The method includes determining a velocity of a user device based on changes in angular orientation or position measured by an inertial measurement unit of the user device. The method also includes determining a transmission frequency based on the velocity of the user device. Additionally, the method includes causing a first transceiver to communicate with a second transceiver according to the transmission frequency. The first transceiver is a component of the user device and is configured to transmit and receive signals. The second transceiver is a component of a handoff device. Further, the method includes determining a separation between the first transceiver and the second transceiver based on signals received by the first transceiver. In addition, the method includes comparing the separation between the first transceiver and the second transceiver to a first range threshold. Even further, the method includes causing the handoff device to output a piece of media when the separation between the first transceiver and the second transceiver is less than the first range threshold.

In yet another aspect, a system is provided. The system includes a means-for determining a velocity of a user device based on changes in angular orientation or position measured by an inertial measurement unit of the user device. The system also includes a means-for determining a transmission frequency based on the velocity of the user device. Additionally, the system includes a means-for causing a first transceiver to communicate with a second transceiver according to the transmission frequency. The first transceiver is a component of the user device and is configured to transmit and receive signals. The second transceiver is a component of a handoff device. Further, the system includes a means-for determining a separation between the first transceiver and the second transceiver based on signals received by the first transceiver. In addition, the system includes a means-for comparing the separation between the first transceiver and the second transceiver to a first range threshold. Yet further, the system includes a means-for causing the handoff device to output a piece of media when the separation between the first transceiver and the second transceiver is less than the first range threshold.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 illustrates a computing device, according to example embodiments.

FIG. 2 illustrates a computing system, according to example embodiments.

FIG. 3 is an illustration of a system, according to example embodiments.

FIG. 4 is a communication flow diagram of a communication protocol, according to example embodiments.

FIG. 5A is an illustration of a system performing a portion of a media handoff method, according to example embodiments.

FIG. 5B is an illustration of a system performing a portion of a media handoff method, according to example embodiments.

FIG. 5C is an illustration of a system performing a portion of a media handoff method, according to example embodiments.

FIG. 6A is a flowchart illustration of a method, according to example embodiments.

FIG. 6B is a flowchart illustration of a method, according to example embodiments.

FIG. 6C is a flowchart illustration of a method, according to example embodiments.

FIG. 7 is a flowchart illustration of a method, according to example embodiments.

### DETAILED DESCRIPTION

Example methods and systems are contemplated herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. Further, some of the illustrated elements may be combined or omitted. Yet further, an example embodiment may include elements that are not illustrated in the figures.

The term “media handoff” is used throughout this disclosure. It is understood that this term is to be construed broadly and covers a wide range of activities using various devices. The term media handoff typically includes one or more devices (e.g., a user device) causing one or more other devices (e.g., a handoff device) to output media. A media handoff may be triggered by one or more trigger conditions, for example. Further, while media handoffs may include causing another device to play music (e.g., play a song from a speaker of the handoff device), media handoffs are not limited to music, or even sound. The media that is handed off may include a video with sound, a still image, a series of still images (i.e., a video without sound), a phone call, etc. Additionally, while the initial device (e.g., the user device) may cease outputting a piece of media as a result of a media handoff, this is not required. A media handoff may include one device causing another to output media while still itself, thereafter, continuing to output the media. Still further, a media handoff may also include handing off only a portion of the media. For example, a user device may be playing a video (e.g., displaying a series of images and outputting associated sound) prior to a media handoff, but, after a media handoff with a smart speaker, may continue to display the series of images while the smart speaker outputs the associated sound. Yet further, while many examples are provided herein of a user device (e.g., a mobile phone) handing a piece of media off to a handoff device (e.g., a television or smart-speaker), it is understood that media could be handed off in the reverse direction (e.g., from the television or smart-speaker to the mobile phone).

Further, while ultra-wideband (UWB) transceivers are used throughout the disclosure as example transceivers by which a user device and a handoff device may communicate relative position and/or orientation with one another, it is understood that other transceivers (e.g., other transceivers that transmit/receive radio signals) are also possible and are contemplated herein. For example WIFI transceivers and/or BLUETOOTH® transceivers (e.g., High Accuracy Distance Measurement BLUETOOTH® transceivers) could be used within a user device and/or a handoff device to transmit signals usable to determine relative orientation and/or position. Additionally, in some embodiments, a combination of transceivers (e.g., a combination of BLUETOOTH® transceivers and UWB transceivers) may be used by the user device and/or the handoff device to determine relative orientation and/or position.

### I. Overview

Described herein are techniques that can be used by a user device (e.g., a mobile phone, a tablet, a smartwatch, a smart wristband, etc.) to execute a media handoff with a handoff device (e.g., a television, a speaker, a smart appliance, etc.). For example, a mobile phone may be playing a song out of a speaker of the mobile phone (e.g., with a display of the mobile phone on or off). Then, once the mobile phone is placed nearby a smart speaker, the smart speaker may begin playing the song and the mobile phone may cease playing the song. Other types of media being handed off are also contemplated herein (e.g., video stream). Further, a reverse handoff (i.e., a handoff from the handoff device back to the user device) is also contemplated herein. Additionally, in some embodiments, the user device may discover one or more potential handoff devices in a vicinity of the user device using BLUETOOTH® Low Energy (BLE) discovery.

As indicated above, the media handoff between the user device and the handoff device may be initiated when the user device is moved to a location near the handoff device. Determining when the user device is nearby the handoff device may be determined based on UWB signals communicated between the user device and the handoff device. Such communication may be initiated by a selection of a specific application, by engaging a specific button within an application on the user device using a user interface (e.g., a user beginning to play a song on a streaming service application on a mobile phone), or by enabling a particular feature in a settings menu of the user device. As described herein, the user device may include a first UWB transceiver. The first UWB transceiver may communicate with a second UWB transceiver of the handoff device. Communicating with the second UWB transceiver may include the first UWB transceiver transmitting a first UWB signal to the second UWB transceiver. Upon receiving the first UWB signal, the handoff device (e.g., a controller of the second UWB transceiver or a processor connected to the second UWB transceiver) may determine an orientation of the first UWB transceiver relative to the second UWB transceiver. Additionally or alternatively, upon receiving the first UWB signal, the handoff device (e.g., a controller of the second UWB transceiver or a processor connected to the second UWB transceiver) may determine a distance (i.e., a range) separating the first UWB transceiver from the second UWB transceiver.

Upon the handoff device determining the orientation and/or the position of the first UWB transceiver relative to the second UWB transceiver, the orientation and/or the position of the first UWB transceiver relative to the second UWB transceiver may then be communicated back to the user device. For example, the second UWB transceiver may transmit a second UWB signal to the first UWB transceiver, where the second UWB signal contains information indicative of an orientation and a position of the first UWB transceiver relative to the second UWB transceiver.

In alternative embodiments, the second UWB transceiver of the handoff device may instead respond to receiving the first UWB signal with a second UWB signal that includes raw data (e.g., data regarding arrival times of the first UWB signal at different antennas within the second UWB transceiver), rather than processed data. This raw data may then be processed by the user device (e.g., by a controller of the first UWB transceiver or a processor of the user device) to determine the orientation and/or position of the first UWB transceiver relative to the second UWB transceiver. As such, the raw data contained in the second UWB signal may nonetheless still be indicative of an orientation and a position of the first UWB transceiver relative to the second UWB transceiver.

The user device may transmit a series of UWB signals and receive a corresponding series of UWB signals indicative of the position and/or orientation of the first UWB transceiver relative to the second UWB transceiver. Each of the transmitted and/or received UWB signals may include an associated timestamp, for example. Using the series of received UWB signals, the user device (e.g., a processor executing instructions stored in a memory of the user device) may determine changes in the orientation or the position of the first UWB transceiver relative to the second UWB transceiver over time (e.g., based on the timestamps). Based on these determined changes, the user device may determine a separation between the first UWB transceiver (and, relatedly, the user device itself) and the second UWB transceiver (and, relatedly, the handoff device itself). The user device (e.g., a processor of the user device) may compare this separation to a threshold separation. If the separation is less than the threshold separation, the user device may initiate a media handoff.

Additional or alternative media handoff trigger conditions (e.g., besides separation between the user device and the handoff device) are also possible and are contemplated herein. For example, if the user device is separated from the handoff device by a distance that is greater than a first threshold separation but less than a second threshold separation (i.e., the user device is somewhat close to the handoff device, but not extremely close to the handoff device), a notification may be displayed on a display of the user device. Thereafter, a user may provide feedback to the user device (e.g., by pressing a button displayed on the display of the user device) to indicate whether a media handoff is desired. If the user provides affirmative feedback within a specified amount of time, a media handoff may be executed by the user device/handoff device.

In still other embodiments, a media handoff may be triggered when the user device is not in proximity to the handoff device and/or if the user device is not in motion at all. For example, the media handoff may be triggered when the user device is pointed toward the handoff device (e.g., when a predefined axis of the user device is oriented parallel to a predefined axis of the handoff device). Determining whether the user device is pointed toward the handoff device may be done based on UWB signals communicated between a UWB transceiver of the user device and a UWB transceiver of the handoff device. Once the user device is pointed toward the handoff device, the user device may request a media handoff confirmation (e.g., from a user via a display of the user device or haptic feedback). Upon receiving a media handoff confirmation (e.g., via a button press on a display of the user device; via a gesture traced out by the user device, such as a shake, swipe, or rotation of the user device; via a spoken confirmation received at a microphone of the user device; etc.), the user device may execute a media handoff with the handoff device.

As described above, one or more determinations about a position and/or orientation of the user device relative to the handoff device may be made in the process of determining whether a media handoff is to be performed. As also mentioned, these determinations may be made based on UWB signals transmitted between the first UWB transceiver of the user device and the second UWB transceiver of the handoff device. Transmitting and receiving UWB signals can consume energy (e.g., stored within a battery) of the user device, though. Because of this, embodiments described herein may modulate a UWB transmission frequency based on a rate of motion (e.g., speed) of the user device. For example, the user device may use an inertial measurement unit (IMU) (e.g., accelerometer) to determine a speed at which the user device is moving, as IMU measurements may consume less energy than transmitting and receiving a pair of UWB signals with the handoff device. Then, based on the speed of the user device, a UWB transmission frequency can be set (e.g., with higher frequencies of motion corresponding to higher UWB transmission frequencies and lower frequencies of motion corresponding to lower UWB transmission frequencies). The UWB transmission frequency can be binary (e.g., either a high UWB transmission frequency or a low UWB transmission frequency) or a continuum based on the speed of the user device (e.g., ranging from a UWB transmission frequency of 0 when the user device is not moving to a maximum UWB transmission frequency when the user device is moving faster than a maximum threshold velocity), in various embodiments. Other UWB transmission frequency schemes are also possible and contemplated herein. Further, the UWB transmission frequency may be repeatedly updated as new measurements from the IMU are made. After a UWB transmission frequency is set, the first UWB transceiver of the user device may transmit UWB signals to and receive UWB signals from the second UWB transceiver of the handoff device at the UWB transmission frequency. Because UWB signals may be more accurate for determining relative position and/or orientation of the user device than IMU measurements (e.g., employing dead reckoning techniques), using this methodology, accurate positioning and/or orientation of the user device can be made using UWB communications while preventing unnecessary oversampling and energy waste by incorporating IMU measurements.

Likewise, in order to avoid unnecessary UWB communications/BLE discoveries, the techniques described herein might only be performed when the user device is currently outputting media (e.g., playing music or displaying a video). Further, in some embodiments, the techniques described herein might only be performed when a display of the user device is currently on (e.g., tacitly indicating that a media handoff may be desired). However, in some embodiments, the user device may continue to monitor its position and/or orientation for a short time (e.g., 3 seconds, 4 seconds, 5 seconds, 6 seconds, 7 seconds, 8 seconds, 9 seconds, or 10 seconds) after the display of the user device is turned off. In this way, if the user device is moved close to the handoff device soon after the display of the user device is turned off, a media handoff could still be performed (e.g., reducing the number of false negatives associated with media handoff detections). In still other embodiments, the user device may perform all the motion monitoring (e.g., using an IMU of the user device and/or UWB signals communicated with the handoff device) and media handoff techniques described herein while the display of the user device is off. For example, once a user provides an indication that a media handoff is contemplated (e.g., by pressing one or more buttons and/or tracing out a gesture using the user device), the user device may begin determining whether and to which handoff device to perform a media handoff (e.g., provided a piece of media, such as music, is currently being output by the user device).

Regardless of how the media handoff is triggered, in order to execute the media handoff in some embodiments, the user device may cease outputting the media (e.g., stop playing the song from a speaker of the user device). Additionally, the user device may transmit command(s) to the handoff device to cause the handoff device to begin outputting the media (e.g., start playing the song from the speaker of the handoff device). For example, the user device may transmit a command UWB signal from the first UWB transceiver to the second UWB transceiver that indicates to the handoff device to begin outputting the media. In some embodiments, the command may be transmitted from the user device to the handoff device using communication channels other than UWB. For example, the user device may transmit the command to the handoff device using BLUETOOTH®, WIFI, infrared signals, etc. In some embodiments, the command signal(s) transmitted from the user device to the handoff device may include a stream of data representing the media to be outputted (e.g., the user device may transmit a digital version of a song to the handoff device via the command signal). Additionally or alternatively, the command signal(s) may include a link (e.g., with associated access credentials) to a copy of the piece of media stored within a digital repository. For example, the command signal may include a unique identifier for the piece of media within an application and/or a media streaming service (e.g., NETFLIX®, HBO MAX®, SPOTIFY®, PANDORA®, HULU®, DISNEY+®, AMAZON PRIME VIDEO®, FUBO TV®, SLING TV®, PEACOCK TV®, YOUTUBE TV®, YOUTUBE®, etc.) and/or user login credentials (e.g., username and password) for the application/media streaming service.

### II. Example Embodiments

The following description and accompanying drawings will elucidate features of various example embodiments. The embodiments provided are by way of example, and are not intended to be limiting. As such, the dimensions of the drawings are not necessarily to scale.

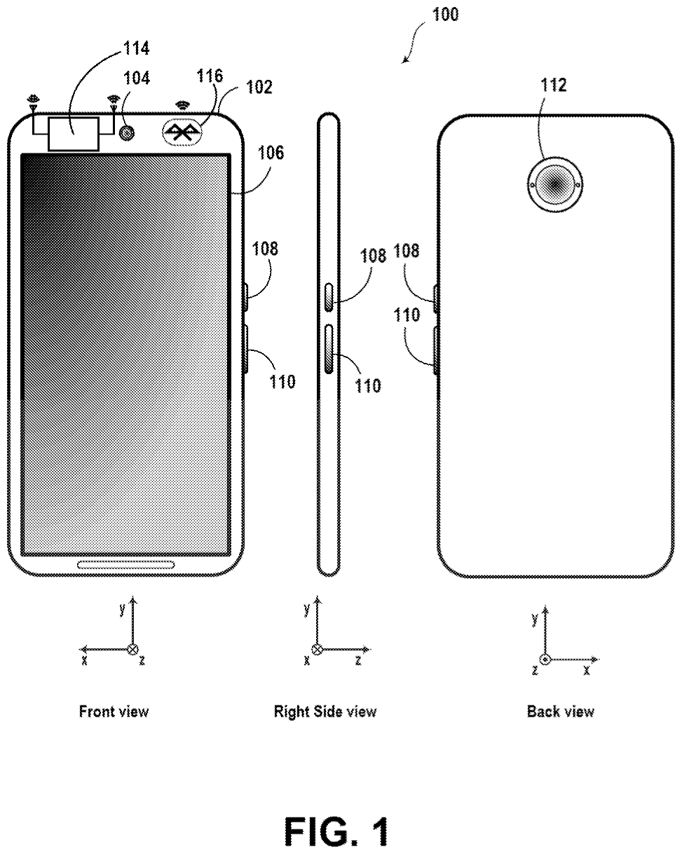

FIG. 1 illustrates an example user device 100. User device 100 is shown in the form factor of a mobile phone. However, user device 100 may be alternatively implemented as a desktop computer, a laptop computer, a tablet, a wearable computing device (e.g., a watch or a wristband), or a remote control, among other possibilities. User device 100 may include various elements, such as body 102, display 106, buttons 108 and 110, a first UWB transceiver 114, and a first BLUETOOTH® (e.g., BLE) transceiver 116. User device 100 may further include one or more cameras, such as front-facing camera 104 and rear-facing camera 112.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and user device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may serve as a viewfinder for front-facing camera 104 and/or rear-facing camera 112. Display 106 may also support touchscreen functions that allow for interaction with aspects of user device 100.

The first UWB transceiver 114 may be usable by the user device 100 to communicate with one or more other devices (e.g., based on one or more processes performed by a processor of the user device 100). In some embodiments, the first UWB transceiver 114 may be internal to the user device 100 (e.g., not visible from the exterior of the user device 100 illustrated in FIG. 1). The first UWB transceiver 114 may include one or more antennas configured to radiate electromagnetic waves. In some embodiments, the electromagnetic waves radiated by the first UWB transceiver 114 may be within the radio portion of the electromagnetic spectrum. Further, the electromagnetic waves radiated by the first UWB transceiver 114 may have a relatively large bandwidth (e.g., between 475 MHz and 525 MHz). In some embodiments, the bandwidth of the electromagnetic waves radiated by the first UWB transceiver 114 may meet the definition of UWB provided by the Federal Communications Commission (FCC) (e.g., the bandwidth exceeds the lesser of 500 MHz or 20% of the arithmetic center frequency). Alternatively, in some embodiments, the bandwidth of the electromagnetic waves radiated by the first UWB transceiver 114 may be less than 500 MHz and less than 20% of the arithmetic center frequency (i.e., the electromagnetic waves transmitted by the first UWB transceiver 114 may not exactly meet the FCC's definition of UWB). The first UWB transceiver 114 may allow for communication with other UWB transceivers at close range and use only small amounts of energy to do so. As such, communicating using the first UWB transceiver 114 may conserve battery life for the user device 100 relative to communicating using other techniques.

In addition to transmitting and receiving data to other devices, the first UWB transceiver 114 may be used to determine an orientation and a position of the first UWB transceiver 114 relative to other UWB transceivers with which it communicates, as described herein. Such orientation and position information may be used by the user device 100 to identify a gesture traced out by the first UWB transceiver 114 and/or the user device 100. Such identified gestures may be used to provide instructions to the user device 100 and/or may be used by the user device 100 to determine commands or other communications to transmit to other devices (e.g., using the first UWB transceiver 114 or another communication technique).

The first BLE transceiver 116 may be used by the user device 100 to communicate with other BLUETOOTH®-enabled devices over BLUETOOTH® frequencies (e.g., between 2.402 and 2.480 GHz) at relatively short distances (e.g., up to 100 m). Such BLUETOOTH® communication may occur according to the IEEE 802.15.1 standard, for example. In some embodiments, the first BLE transceiver 116 may be internal to the user device 100 (e.g., not visible from the exterior of the user device 100 illustrated in FIG. 1). In some embodiments, the first BLE transceiver 116 may be used to broadcast a discovery signal in order to discover other BLUETOOTH®-enabled devices in a vicinity of the user device 100. Other BLUETOOTH®-enabled devices may respond to the discovery signal (e.g., transmit a response signal that includes identification information or information about a communication protocol) to establish a connection with the user device 100 such that the user device 100. While the first BLE transceiver 116 is described herein as a BLUETOOTH® Low Energy transceiver, it is understood that other types of BLUETOOTH® transceivers or other short-range communications modules could be used instead of or in addition to a BLUETOOTH® Low Energy transceiver.

While not illustrated in FIG. 1, it is understood that the user device 100 may also include an IMU. The IMU may be internal to the user device 100 (e.g., not visible from the exterior of the user device 100 illustrated in FIG. 1). The IMU may be configured to determine an orientation and/or direction of motion of the user device 100 (e.g., relative to a gravitational field of the Earth) and provide information relative to the orientation and/or direction of motion of the user device 100 to a processor of the user device 100. In order to determine the orientation and/or direction of motion of the user device 100, the IMU may include one or more accelerometers, one or more gyroscopes, and/or one or more magnetometers. Such devices may convert physical forces (e.g., gravity or other outside forces applied to the user device 100, such as by a user) into electric signals, for example, that can be interpreted by a processor of the user device 100. A processor of the user device 100 may use the electric signals from the IMU over time to determine absolute position and/or angular orientation of the user device 100 (e.g., using dead reckoning). As described herein, in some embodiments, determinations made by the IMU about the angular orientation and/or position of the user device 100 may be used in addition to communications between the first UWB transceiver 114 and other UWB transceivers to determine an angular orientation and/or position of the user device 100 over time.

User device 100 may also include an ambient light sensor that may continuously or from time to time determine the ambient brightness of an environment in which user device 100 is present. In some implementations, the ambient light sensor can be used to adjust the display brightness of display 106. Additionally, the ambient light sensor may be used to determine an exposure length of one or more of cameras 104 or 112, or to help in this determination.

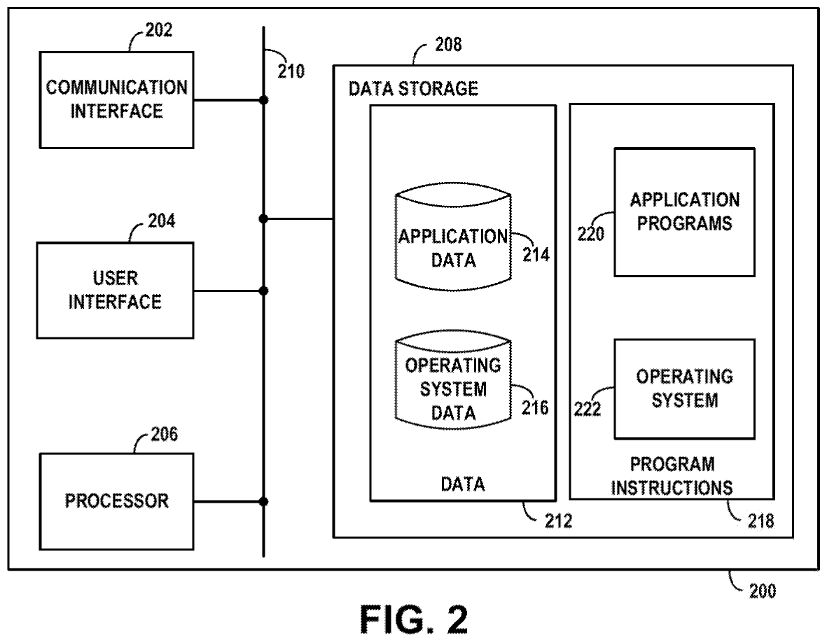

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, or handheld computer), a home automation component, a digital video recorder (DVR), a digital television, a remote control, a wearable computing device (e.g., a smartwatch or a smart wristband), a gaming console, a robotic device, a vehicle, or some other type of device. Computing system 200 may represent, for example, aspects of user device 100. As shown in FIG. 2, computing system 200 may include communication interface 202, user interface 204, processor 206, and data storage 208, all of which may be communicatively linked together by a system bus, network, or other connection mechanism 210.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port. Communication interface 202 may also take the form of or include a wireless interface, such as a WIFI, BLUETOOTH®, global navigation satellite system (GNSS), or wide-area wireless interface (e.g., WiMAX, 3GPP Long-Term Evolution (LTE), and/or 3GPP 5G). However, other forms of physical layer interfaces and other types of standard or proprietary communication protocols may be used over communication interface 202. Furthermore, communication interface 202 may include multiple physical communication interfaces (e.g., a WIFI interface; a BLUETOOTH® interface, such as the first BLE transceiver 116 shown and described with reference to FIG. 1; and a wide-area wireless interface). In some embodiments, the communication interface 202 may include the first UWB transceiver 114 shown and described with reference to FIG. 1.

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen which, for example, may be combined with a touch-sensitive panel. The display screen may be based on CRT, LCD, and/or LED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may include one or more general purpose processors (e.g., microprocessors) and/or one or more special-purpose processors (e.g., digital signal processors (DSPs), graphics processing units (GPUs), floating point units (FPUs), network processors, or application-specific integrated circuits (ASICs)). In some instances, special-purpose processors may be capable of image processing and/or execution of machine-learning models, among other possibilities. Data storage 208 may include one or more volatile and/or non-volatile memories, such as magnetic, optical, flash, or organic storage, and may be integrated, in whole or in part, with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 (e.g., sets of instructions) by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

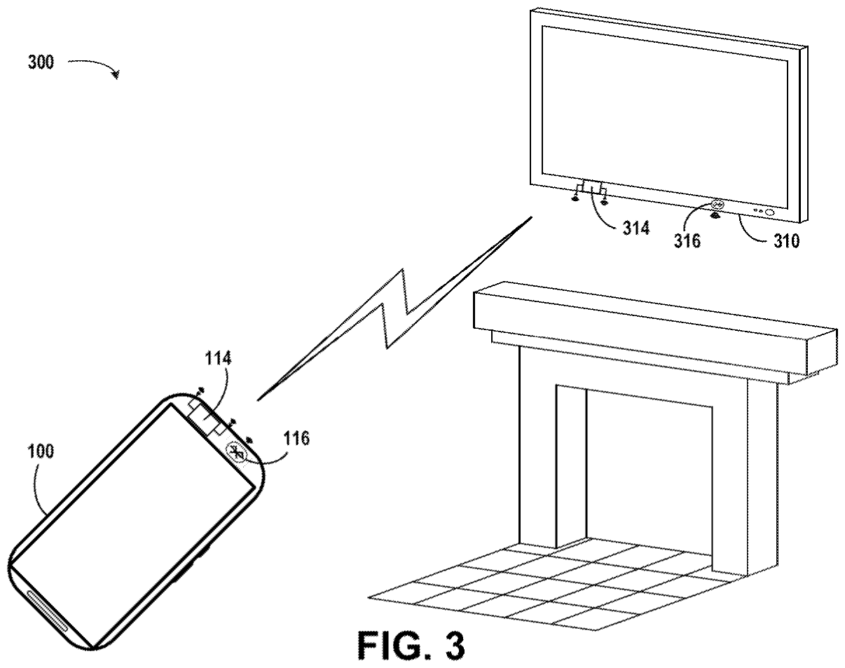

FIG. 3 is an illustration of a system 300, according to example embodiments. The system 300 includes user device 100 as shown and described with reference to FIG. 1 and a handoff device 310. As illustrated in FIG. 3, the user device 100 may be a mobile phone. It is understood, however, that other embodiments of the user device 100 are also possible and contemplated herein (e.g., a watch, a wristband, a tablet, a remote control, etc.). Similarly, as illustrated in FIG. 3, the handoff device 310 may be a television. Likewise, though, it is understood that other embodiments of the handoff device 310 are also possible and contemplated herein (e.g., a speaker/smart-speaker, a thermostat, a smart-home hub, a desktop computer, a tablet, a kitchen appliance, a washer, a dryer, etc.).

As illustrated, the user device 100 may include a first UWB transceiver 114 and a first BLE transceiver 116. Similarly, the handoff device 310 may include a second UWB transceiver 314 and a second BLE transceiver 316. The first UWB transceiver 114 may be configured to transmit and receive UWB signals using one or more antennas. Such UWB signals may correspond to electromagnetic waves in the radio spectrum (e.g., between 1 GHz and 10 GHz) having a relatively broad bandwidth (e.g., between 475 MHz and 525 MHz). Similarly, the first BLE transceiver 116 may be configured to transmit and receive BLUETOOTH® signals. Such BLUETOOTH® signals may correspond to ultra high frequency (UHF) radio waves having frequencies between 2.402 GHz and 2.480 GHz (e.g., and a lower bandwidth than the UWB signals communicated by the first UWB transceiver 114 and the second UWB transceiver 314).

In some embodiments, the first UWB transceiver 114 may be configured similarly or identically to the second UWB transceiver 314. For example, both the first UWB transceiver 114 and the second UWB transceiver 314 may be capable of transmitting and receiving UWB signals. Additionally, the first UWB transceiver 114 and the second UWB transceiver 314 may transmit UWB signals that have the same bandwidth. Further, the first UWB transceiver 114 and the second UWB transceiver 314 may both include the same number of antennas. In other embodiments, though, the first UWB transceiver 114 and the second UWB transceiver 314 may be different in one or more ways (e.g., different numbers of antennas). Similarly, the first BLE transceiver 116 and the second BLE transceiver 316 may be configured similarly or identically to one another. For example, the first BLE transceiver 116 and the second BLE transceiver 316 may both be configured to both transmit and receive BLUETOOTH® signals. In some embodiments, though, the first BLE transceiver 116 and the second BLE transceiver 316 may have different components and/or capabilities. For example, the range of the first BLE transceiver 116 may be longer than the second BLE transceiver 316 or the first BLE transceiver 116 may be capable of broadcasting BLUETOOTH® discovery signals, while the second BLE transceiver 316 is only capable of responding to BLUETOOTH® discovery signals.

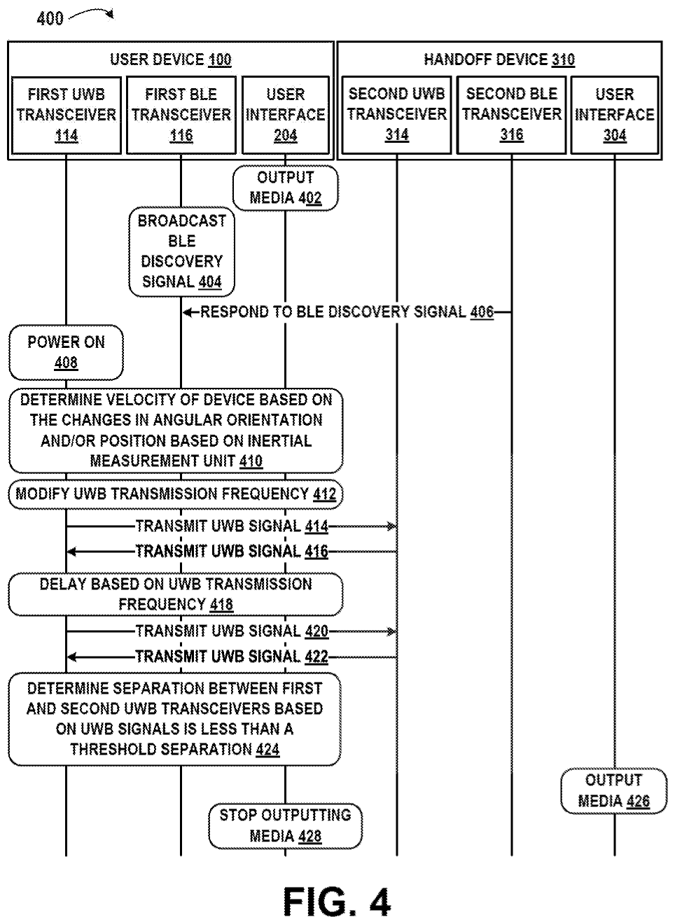

As described above, the first BLE transceiver 116 may be configured to transmit a BLUETOOTH® discovery signal. The BLUETOOTH® discovery signal may be used by the user device 100 to discover other BLUETOOTH®-enabled devices in the vicinity of the user device 100. One or more nearby BLUETOOTH® t-enabled devices, such as the handoff device 310 (e.g., using the second BLE transceiver 316), may respond to a BLUETOOTH® discovery signal transmitted by the first BLE transceiver 116 to indicate the ability to connect (e.g., to connect for BLUETOOTH® communication or other communication). For example, in the system 300 in FIG. 3, the first BLE transceiver 116 may transmit a BLUETOOTH® discovery signal that is received by the second BLE transceiver 316. In response to the BLUETOOTH®, discovery signal, the second BLE transceiver 316 may transmit a response signal to the first BLE transceiver 116 to indicate to the user device 100 that the handoff device 310 is available to connect (e.g., for a media handoff). Thereafter, the first UWB transceiver 114 and the second UWB transceiver 314 may communicate with one another to determine an orientation and/or position of the first UWB transceiver 114 relative to the second UWB transceiver 314 in the process of performing a media handoff. This communication protocol is shown and described with reference to FIG. 4.

While BLUETOOTH® communication using the first BLE transceiver 116 and the second BLE transceiver 316 may enable efficient discovery (i.e., lower power consumption discovery) of nearby devices for media handoff, it is understood that such a discovery process is not required. In some embodiments, the first UWB transceiver 114 may begin transmitting UWB signals to the handoff device 310 without first initiating contact using BLUETOOTH® (i.e., lower power consumption) signals. As such, in some embodiments, the user device 100 may not include the first BLE transceiver 116 and/or the handoff device 310 may not include the second BLE transceiver 316.

Regardless of how the communication between the user device 100 and the handoff device 310 is initiated, the first UWB transceiver 114 may communicate with the second UWB transceiver 314 to determine an orientation and/or position of the first UWB transceiver 114 relative to the second UWB transceiver 314. For example, the first UWB transceiver 114 may transmit a first UWB signal to the second UWB transceiver 314. Then, in response, the second UWB transceiver 314 may respond with a second UWB signal. The second UWB signal may be indicative of the orientation and/or position of the first UWB transceiver 114 relative to the second UWB transceiver 314. This communication methodology may be repeated multiple times to monitor changes in orientation and/or position of the first UWB transceiver 114 relative to the second UWB transceiver 314 over time.

For example, the second UWB signal may have an associated transmission timestamp (e.g., an indication of when the second UWB transceiver 314 transmitted the second UWB signal), which can be compared to a reception timestamp (e.g., an indication of when the first UWB transceiver 114 received the second UWB signal) to determine transit time. In some examples, the transmission timestamp and/or the reception timestamp may be accurate to within 1 ns or less due to the bandwidth (e.g., between 475 MHz and 525 MHz) used to communicate the second UWB signal. Using the speed of light along with the transit time (i.e., reception timestamp minus transmission timestamp), the distance between the first UWB transceiver 14 and the second UWB transceiver 314 can be determined (e.g., to an accuracy of between 5 cm and 50 cm). In other embodiments, the handoff device 310 (e.g., a processor of the handoff device 310) may instead compare a transmission timestamp to a reception timestamp of a first UWB signal (e.g., a signal sent by the first UWB transceiver 114 and received by the second UWB transceiver 314), rather than the second UWB signal sent by the second UWB transceiver 314 and received by the first UWB transceiver 114. In this way, the handoff device 310 may determine a separation (i.e., range) between the user device 100 and the handoff device 310. This separation may then be transmitted (e.g., as a range value encoded as a series of bits) by the second UWB transceiver 314 to the first UWB transceiver 114.

The second UWB signal may also be usable to determine an orientation of the first UWB transceiver 114 relative to the second UWB transceiver 314 (e.g., to within an accuracy of 5°). For example, if the first UWB transceiver includes two antennas (e.g., separated by half of the center wavelength of the second UWB signal or less), the difference in arrival time between when a first antenna receives the second UWB signal and when a second antenna receives the second UWB signal, along with a predetermined separation between the antennas (e.g., based on manufacturing specifications of the first UWB transceiver 114) and the speed of light, can be used to trigonometrically determine the angular position (e.g., in azimuth and/or elevation) of the second UWB transceiver 314 relative to the two antennas of the first UWB transceiver 114. Additionally, the second UWB transceiver 314 may transmit an additional UWB signal (e.g., from an additional antenna of the second UWB transceiver 314). In the case where the second UWB transceiver 314 transmits multiple response UWB signals from multiple antennas at different locations or multiple response UWB signals from a single antenna at different times, the response UWB signals can be used to determine the orientation of the first UWB transceiver 114 relative to the second UWB transceiver 314 in multiple angular directions (e.g., in azimuthal and/or elevation directions based on the orientation of the antennas in the first UWB transceiver 314). Such a determination of the orientation of the first UWB transceiver 114 may be based on the speed of light, the predetermined separation between the antennas of the first UWB transceiver 114, and/or the predetermined separation between the antennas of the second UWB transceiver 314 from which the different response UWB signals are transmitted.

In some embodiments, a processor (e.g., the processor 206 shown and described with reference to FIG. 2) of the user device 100 may analyze the second UWB signal received by the first UWB transceiver 114 to determine the orientation and/or position of the first UWB transceiver 114 relative to the second UWB transceiver 314. Alternatively, a controller associated with the first UWB transceiver 114 may analyze the second UWB signal to determine the orientation and/or position of the first UWB transceiver 114 relative to the second UWB transceiver 314 and then transmit (e.g., over a system bus, such as the connection mechanism 210 shown and described with reference to FIG. 2) the orientation and/or position of the first UWB transceiver 114 to a processor (e.g., the processor 206 shown and described with reference to FIG. 2) of the user device 100. Regardless of how the orientation and/or position of the first UWB transceiver 114 relative to the second UWB transceiver 314 is determined, the orientation and/or position of the first UWB transceiver 114 may be stored within a memory of the user device 100 (e.g., with an associated timestamp).

In some embodiments, upon receiving or determining the orientation and/or position of the first UWB transceiver 114 relative to the second UWB transceiver 314, a processor of the user device 100 may perform one or more geometric transformations to determine a position of the entire user device 100 relative to the second UWB transceiver 314 and/or relative to the entire handoff device 310. Such transformation(s) may be based on one or more three-dimensional models of the user device 100 and/or handoff device 310 stored within a memory of the user device 100.

Upon the user device 100 (e.g., a processor of the user device) determining an orientation and/or position of the first UWB transceiver 114 relative to the second UWB transceiver 314 (and/or upon determining an orientation and/or position of the user device 100, as a whole, relative to the handoff device 310), the orientation and/or position information may be stored within a repository in a memory of the user device 100 with an associated timestamp. For example, an entry in the repository may include a global timestamp (e.g., in ms), a range (e.g., in meters) between the first UWB transceiver 114 and the second UWB transceiver 314, an azimuthal angle (e.g., in degrees) between the first UWB transceiver 114 and the second UWB transceiver 314, and an elevation angle (e.g., in degrees) between the first UWB transceiver 114 and the second UWB transceiver 314.

By analyzing a series of entries with associated timestamps, the user device 100 (e.g., a processor of the user device 100) may be able to identify one or more gestures (e.g., a swipe, a rotation, etc.) traced out by the first UWB transceiver 114/user device 100 (e.g., by a user tracing out such gestures with the user device 100 in-hand). For example, the processor of the user device 100 may determine changes in orientation and/or position of the first UWB transceiver 114 relative to the second UWB transceiver 314 overtime (e.g., based on the entries within the repository in the memory of the user device 100). Additionally or alternatively, the user device 100 (e.g., a processor of the user device 100) may analyze one or more of the entries to determine whether or not to perform a media handoff. For example, if the user device 100 is currently outputting media (e.g., playing music through a speaker of the user device 100) and the user device 100 moves within a threshold distance of the handoff device 310, the user device 100 (e.g., a processor of the user device 100) may determine that a media handoff is to be performed. Media handoff determinations may, in various embodiments, be based on: a separation between the user device 100 and the handoff device 310, an orientation of the first UWB transceiver 114 relative to the second UWB transceiver 314, one or more gestures traced out by the user device 100, whether the user device 100 is currently in motion, whether a display of the user device 100 is currently powered on, whether the user device 100 is presently located in a predefined location (e.g., an “at-home” location), whether the user device 100 is currently outputting media, whether the user device 100 is currently executing an application (e.g., a mobile application) for which media handoff events can be performed, whether a button on the user device 100 (e.g., a physical button on the periphery of the user device 100 or a virtual button presented on a display of the user device 100) has been pressed, and/or whether a setting for enabling media handoffs has been selected within the user device 100.

In some embodiments here, the UWB transmission frequency at which the first UWB transceiver 114 communicates with the second UWB transceiver 314 to determine separations between the user device 100 and the handoff device 310 may be modulated (e.g., to conserve battery life of the user device 100). For example, the user device 100 (e.g., a processor of the user device 100) may determine a speed at which the user device 100 is being moved (e.g., based on measurements of an IMU of the user device 100) and then modulate the UWB transmission frequency based on that speed. If the speed of the user device 100 is slow (and, therefore, the user device 100 is changing locations relative to the handoff device 310 slowly), the UWB transmission frequency may be reduced (e.g., set to a relatively low value). Likewise, as the speed at which the user device 100 is being moved (e.g., based on measurements of an IMU of the user device 100) speeds up, the UWB transmission frequency may be increased (e.g., set to a relatively high value).

If it is determined that a media handoff is to be performed (e.g., by a processor of the user device 100 based on a comparison of the separation between the first UWB transceiver 114 and the second UWB transceiver 314), the user device 100 may transmit one or more signals to the handoff device 310 to cause the handoff device 310 to begin outputting a piece of media (e.g., a piece of media indicated by the one or more signals transmitted to the handoff device 310). Further, the user device 100 may cease outputting the piece of media if a media handoff is to be performed.

FIG. 4 is a communication flow diagram of a communication protocol 400, according to example embodiments. As illustrated in FIG. 4, the communication protocol 400 may be performed based on communications between a user device (e.g., the user device 100 shown and described with reference to FIGS. 1 and 3) and a handoff device (e.g., the handoff device 310 shown and described with reference to FIG. 3). In particular, the communication protocol 400 may include communications between a first UWB transceiver 114 of the user device 100, a first BLE transceiver 116 of the user device 100, a user interface 204 of the user device 100, a second UWB transceiver 314 of the handoff device 310, a second BLE transceiver 316 of the handoff device 310, and a user interface 304 of the handoff device 310. Further, the communication protocol 400 illustrated in FIG. 4 may be performed to handoff media output (e.g., to handoff playing of music) from the user device 100 to the handoff device 310.

At step 402, the communication protocol 400 may include the user interface 204 of the user device 100 (e.g., a speaker of the user device 100) outputting media. For example, step 402 may include a speaker of the user interface 204 playing music or a display of the user interface 204 displaying a video stream.

At step 404, the communication protocol 400 may include the first BLE transceiver 116 of the user device 100 broadcasting a BLE discovery signal.

At step 406, the communication protocol 400 may include the second BLE transceiver 316 of the handoff device 310 responding to the BLE discovery signal. In this way, the handoff device 310 may indicate to the user device 100 that the handoff device 310 is available for media handoff.

At step 408, the communication protocol 400 may include the first UWB transceiver 114 of the user device 100 powering on. This may enable the UWB transceiver 114 to communicate with the second UWB transceiver 314 in future steps, for example.

At step 410, the communication protocol 400 may include the user device 100 (e.g., a processor of the user device 100) determining a velocity of the user device based on the changes in angular orientation and/or position determined based on one or more measurements made by an IMU of the user device 100.

At step 412, the communication protocol 400 may include the user device 100 (e.g., a processor of the user device 100) modifying a UWB transmission frequency.

At step 414, the communication protocol 400 may include the first UWB transceiver 114 of the user device 100 transmitting a UWB signal to the second UWB transceiver 314 of the handoff device 310.

At step 416, the communication protocol 400 may include the second UWB transceiver 314 of the user device 100 transmitting a UWB signal to the first UWB transceiver 114 of the handoff device 310. The UWB signals communicated in steps 414 and 416 may be usable (e.g., by the user device 100) to determine a position and/or orientation of the user device 100 relative to the handoff device 310).

At step 418, the communication protocol 400 may include the user device 100 (e.g., a processor of the user device 100) using a delay prior to step 420, where the delay may be determined based on the UWB transmission frequency modified at step 412. By incorporating delays, the user device 100 may be capable of monitoring a position/orientation of the user device 100 over time without unnecessarily consuming energy (e.g., by transmitting excessive UWB signals when the user device 100 has not moved or has barely moved).

At step 420, the communication protocol 400 may include the first UWB transceiver 114 of the user device 100 transmitting a UWB signal to the second UWB transceiver 314 of the handoff device 310.

At step 422, the communication protocol 400 may include the second UWB transceiver 314 of the handoff device 310 transmitting a UWB signal to the first UWB transceiver 114 of the user device 100. The UWB signals communicated in steps 420 and 422 may be usable (e.g., by the user device 100) to determine a position and/or orientation of the user device 100 relative to the handoff device 310).

At step 424, the communication protocol 400 may include the user device 100 (e.g., a processor of the user device 100) determining a separation between the first UWB transceiver 114 and the second UWB transceiver 314 based on a received UWB signal (e.g., the UWB signal received at step 416 and/or the UWB signal received at step 422) is less than a threshold separation. If the separation between the user device 100 and the handoff device 310 is greater than or equal to the threshold separation, however, the user device 100 may continue monitoring the separation between the user device 100 and the handoff device 310 (e.g., by reverting to step 414 and progressing from there).

At step 426, the communication protocol 400 may include the user interface 304 of the handoff device 310 (e.g., a speaker of the handoff device 310) outputting media. In some embodiments, step 426 may occur in response to the user device 100 transmitting a command to the handoff device 310 that causes the handoff device 310 to begin outputting the media. Such a command may be transmitted as a UWB signal (e.g., from the first UWB transceiver 114 to the second UWB transceiver 314), as a BLE signal (e.g., from the first BLE transceiver 116 to the second BLE transceiver 316), over WIFI (e.g., from the user device 100 to the handoff device 310), using cellular communication protocols, etc.

At step 428, the communication protocol 400 may include the user interface 204 of the user device 100 (e.g., a speaker of the user device 100) ceasing output of media. The combination of steps 426 and 428 may represent a media handoff between user device 100 and handoff device 310. In alternate embodiments, the user device 100 may continue outputting the media even after causing the handoff device 310 to output the media. In other words, in some embodiments, step 428 may not occur and both the user device 100 and the handoff device 310 may simultaneously output the media (or a part of the media).

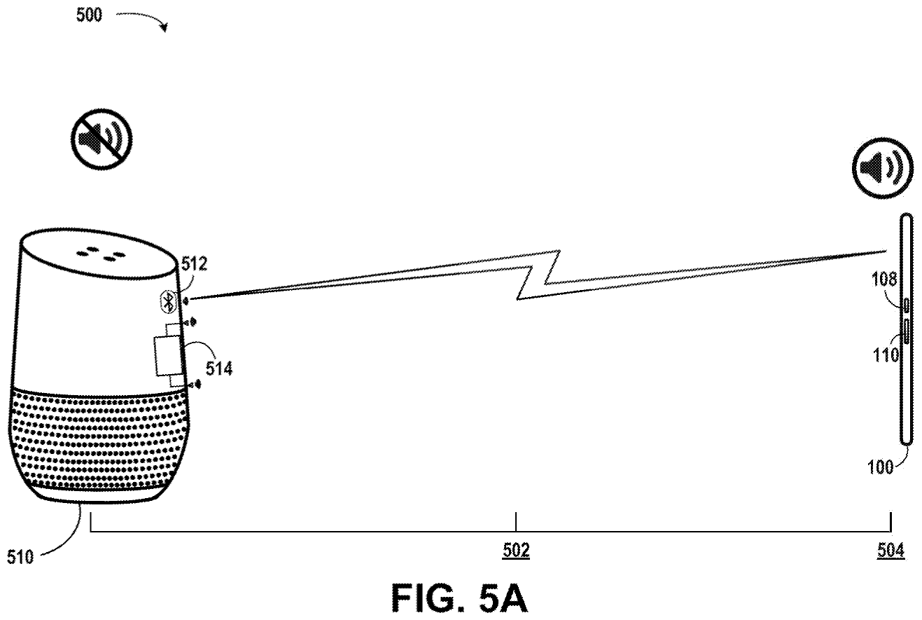

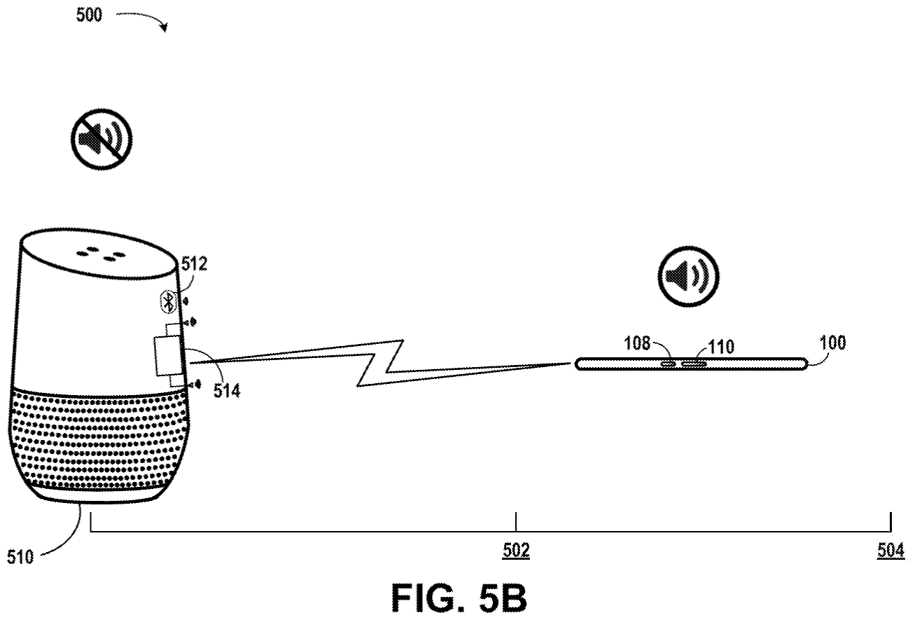

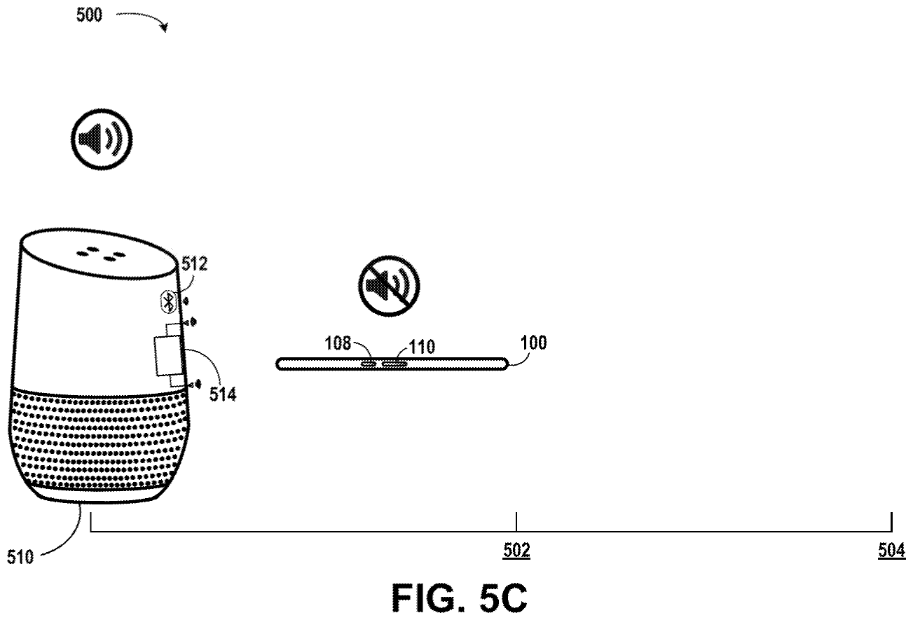

As described above with respect to step 424, prior to performing a media handoff, the user device 100 may compare the separation between the user device 100 and the handoff device 310 (e.g., based on the separation between the first UWB transceiver 114 and the second UWB transceiver 314) to a threshold separation. If the separation between the first UWB transceiver 114 and the second UWB transceiver 314 is less than the threshold separation, a media handoff may be performed. If the separation between the first UWB transceiver 114 and the second UWB transceiver 314 is greater than or equal to the threshold separation, a media handoff may not be performed. In some embodiments, though, there may be two threshold separations (e.g., defining three possible positions for the user device 100 relative to the handoff device 310). FIGS. 5A-5C illustrate a system 500 performing a media handoff event. The system 500 may include the user device 100 and a handoff device 510 (e.g., a smart speaker equipped with a BLE transceiver 512 and a UWB transceiver 514) in an embodiment with two threshold separations (e.g., a first range threshold 502 and a second range threshold 504).

In FIG. 5A, a first portion of a media handoff method is illustrated. The media handoff may be performed by the system 500. Further, in the system 500, three regions may be defined relative to the handoff device 510: a first region (being defined between the handoff device 510 and a first range threshold 502); a second region (being defined between the first range threshold 502 and a second range threshold 504); and a third region (being defined beyond the second range threshold 504). It is understood that, while two range thresholds 502, 504 defining three relative regions are illustrated in FIGS. 5A-5C, other numbers of range thresholds and/or regions are also possible and are contemplated herein. Further, although separations/range thresholds are being illustrated in FIGS. 5A-5C as one-dimensional quantities, it is understood that this is simply for purposes of illustration, and that in various embodiments various types of separation measurements/range thresholds are possible. For example, two-dimensional or three-dimensional separation measurements and/or range thresholds are also possible.

In the first portion of the media handoff method, as illustrated in FIG. 5A, the user device 100 may be located in the third region (e.g., outside of the second range threshold 504). Further, the user device 100 may be outputting media (e.g., playing audio, such as music, as indicated by the sound icon in FIG. 5A; displaying one or more images; etc.). Additionally or alternatively, a display of the user device 100 may currently be powered on when the first portion of the media handoff method illustrated in FIG. 5A is performed. It is understood, though, that various embodiments are possible and contemplated herein. For example, the first portion of the media handoff may be performed when a display of the user device 100 is powered off and/or when the user device 100 is not presently outputting media.

In order to execute the first portion of the media handoff method, the user device 100 may perform a device discovery. Performing a device discovery may include the user device 100 (e.g., a BLE transceiver of the user device 100) communicating with the handoff device 510 (e.g., by broadcasting a BLUETOOTH® discovery signal to the BLE transceiver 512 of the handoff device 510). Further, the handoff device 510 may respond (e.g., by the BLE transceiver 512 transmitting a discovery response) to the user device 100 to provide the user device 100 with information (e.g., location, communication protocols, etc.) about the handoff device 510. The device discovery may be performed by the user device 100 to determine whether any handoff devices are in the vicinity of the user device 100. If a handoff device is discovered by the user device 100, the user device 100 may then proceed to further media handoff steps (e.g., as illustrated in FIGS. 5B and 5C).

In FIG. 5B, a second portion of a media handoff method is illustrated. In the second portion of the media handoff method, as illustrated in FIG. 5B, the user device 100 may be located in the second region (e.g., between the first range threshold 502 and the second range threshold 504) and may be outputting media (e.g., playing music from a speaker of the user device 100). In addition, the user device 100 may have previously discovered the handoff device 510 (e.g., using the technique described above). In the second portion of the media handoff method, the user device 100 (e.g., via the UWB transceiver 114 of the user device 100) may be communicating with the handoff device 510 (e.g., via the UWB transceiver 514 of the handoff device 510) using UWB signals. The UWB signals may be communicated according to a UWB transmission frequency (e.g., which, itself, may be determined based on: the location of the user device 100 relative to the handoff device 510; whether a display of the user device 100 is powered on; whether the user device 100 is pointed at the handoff device 510; whether the user device 100 is currently outputting media; whether the user device 100 is at a predefined location, such as an “at-home” location; how fast the user device 100 is currently moving, as determined based on measurements by an IMU of the user device 100; etc.). The UWB transmission frequency may be modulated as the user device 100 is moved relative to the handoff device 510.

Further, based on these UWB signals, the user device 100 and/or the handoff device 510 may determine an orientation and/or position of the user device 100 relative to the handoff device 510. Still further, the user device 100 and/or the handoff device 510 may track changes in the relative position and/or orientation of the user device 100 over time. Because the user device 100 is not in the first region (i.e., is not closer to the handoff device 510 than the first range threshold 502), the user device 100 may determine that, a media handoff is not yet to be completed or that, in order to complete a media handoff, a confirmation from a user (e.g., based on a prompt, such as a pop-up notification, displayed on a display of the user device 100) must be received prior to completing the media handoff. It is understood that, while FIG. 5B illustrates the communication of UWB signals between the user device 100 and the handoff device 510 while the user device 100 is positioned in the second region relative to the handoff device 510, communication of UWB signals (e.g., to determine the relative position and/or orientation of the user device 100) may additionally or alternatively be performed while the user device 100 is in the first region and/or the third region.

In FIG. 5C, a third portion of a media handoff method is illustrated. In the third portion of the media handoff method, as illustrated in FIG. 5B, the user device 100 may be located in the first region (e.g., between the handoff device 510 and the first range threshold 502) and may no longer be outputting media (e.g., indicated by the sound icon with a slash through it in FIG. 5C). The handoff device 510, on the other hand, may have begun outputting media (e.g., playing music via a speaker of the handoff device 510, as indicated by the sound icon in FIG. 5C). The user device 100 may not be outputting media and the handoff device 510 may be outputting media as a result of the completion of the media handoff. For example, when the user device 100 detected that the user device 100 was closer to the handoff device 510 than the first range threshold 502 (e.g., based on UWB signals communicated between the user device 100 and the handoff device 510), the user device 100 may have transmitted one or more signals to the handoff device 510 to cause the handoff device to begin outputting a piece of media that the user device 100 was previously outputting. Further, after transmitting the one or more signals to the handoff device 510, the user device 100 may have ceased outputting the piece of media as a result of the media handoff. While FIG. 5C illustrates the user device 100 as being in the first region (e.g., between the handoff device 510 and the first range threshold 502), it is understood that, in some embodiments, once the handoff device 510 begins outputting media and the user device 100 ceases outputting media, the user device 100 may be moved away from the handoff device 510 and the handoff device 510 may continue to output media.

In some embodiments, as illustrated in FIG. 5C, the user device 100 may cease communicating with the handoff device 510 using UWB signals once the handoff device 510 begins outputting media. However, in some embodiments, the user device 100 may continue to communicate with the handoff device 510 using UWB signals even after the media handoff is complete. In this way, the relative position and/or orientation of the user device 100 may be determined. The relative position and/or orientation of the user device 100 may continue to be monitored to determine whether a reverse media handoff (i.e., back from the handoff device 510 to the user device 100) is to be performed. For example, if a specific gesture is traced out by the user device 100 (e.g., a swipe, a rotation, etc.), the handoff device 510 may cease outputting the media and the user device 100 may resume outputting the media.

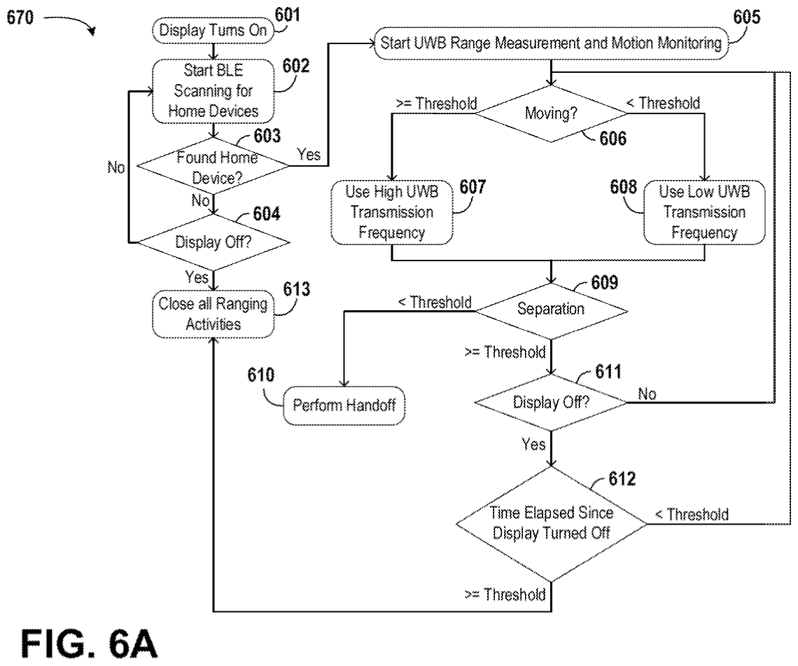

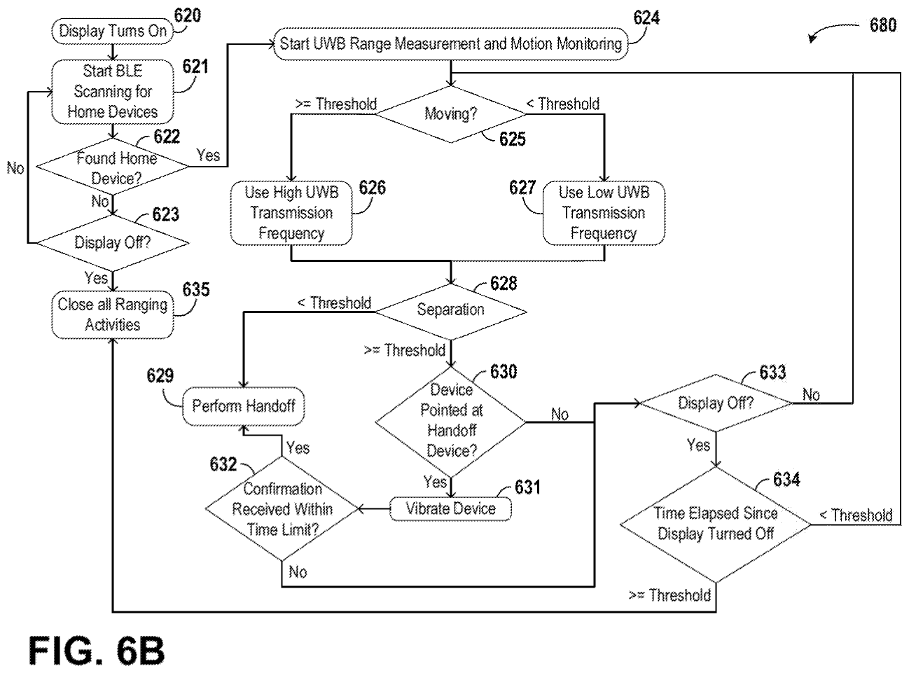

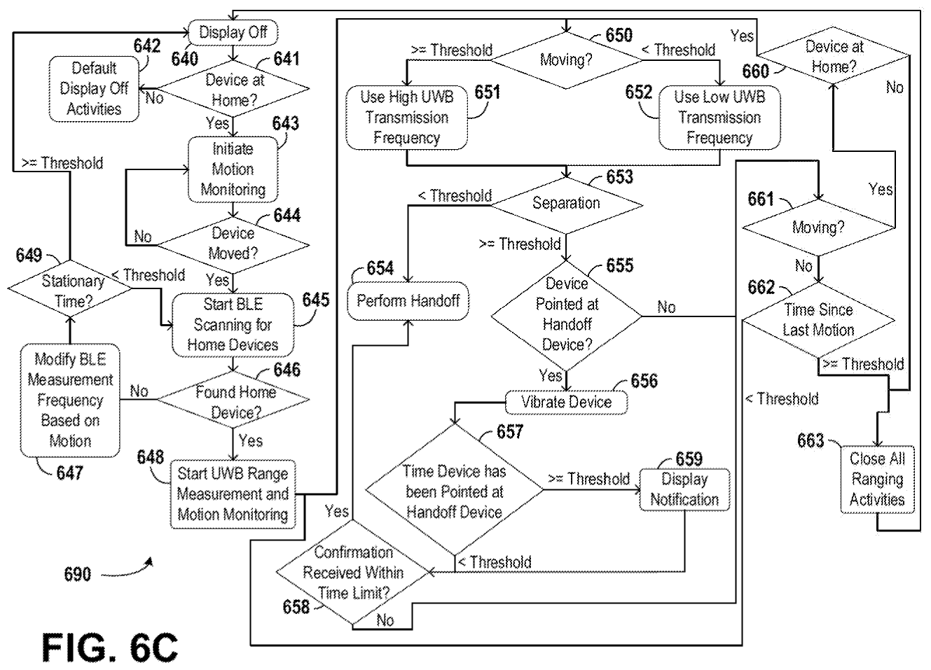

FIGS. 6A-6C are flow-chart illustrations of methods used (e.g., by the user device 100) to perform media handoffs with a handoff device (e.g., the handoff device 510). For example, each of the methods may include one or more actions performed by a processor of the user device 100 executing one or more sets of instructions stored within a memory (i.e., data storage) of the user device 100. Each of the methods illustrated in FIGS. 6A-6C may reduce energy consumption (e.g., form a battery of the user device 100), prevent unintended media handoffs, and/or enhance user control.

For example, each of the methods illustrated in FIGS. 6A-6C may include modulating a UWB transmission frequency (e.g., used to transmit UWB signals between the user device 100 and the handoff device 510) based on whether the user device 100 is presently moving (e.g., as determined by the user device 100 based on measurements made by an IMU of the user device 100). Thus, in situations where the user device 100 is not moving or is moving relatively slowly (and, thus, the location of the user device 100 is not changing as rapidly), a lower UWB transmission frequency may be employed, thereby resulting in less energy being consumed as a result of UWB transmissions.

Likewise, FIGS. 6B and 6C include determinations of whether the user device 100 is pointed toward the handoff device 510, regardless of whether the user device 100 is within a range threshold of the handoff device 510. As such, the methods of FIGS. 6B and 6C may allow for a media handoff to be performed even when the user device 100 is not moving and/or not positioned near the handoff device 510. This may be useful, for example, when a user is seated at a desk and wants to execute a media handoff with a handoff device located across the room from the desk, but does not want to stand up from the desk and move the user device to the other side of the room near the handoff device.

Still further, FIG. 6C may include, when the display of the user device is presently powered off, a determination of whether the user device is currently located at a predefined location (e.g., at an “at-home” location). When the user device is located at the predefined location and being moved, the user device may discover handoff devices and/or attempt to perform media handoffs. However, when the user device is not located at the predefined location, the user device may not attempt to perform a media handoff. This functionality can allow a user to perform a media handoff without turning on a display of the user device, but may simultaneously prevent unnecessary energy consumption by attempting to perform a media handoff when the user device is located in a location that is not the predefined location (e.g., when the user device is away from home).

It is understood that FIGS. 6A-6C are provided solely as illustrative examples. Additional or alternative steps may also be performed in the methods illustrated. For example, in some embodiments, there may be one or more steps to account for communication latency and/or computational latency. For instance, it may require some amount of time to determine the position and/or orientation of one UWB transceiver relative to another (and, consequently, of the user device relative to the handoff device). As such, there may be a time delay inserted between a UWB communication step and a future step that involves analyzing the UWB signals for motion of the user device or making a further determination based on the motion of the user device. Further, in some embodiments, one or more of the steps may be performed in a different order.

FIG. 6A illustrates a method 670, according to example embodiments. The method may be carried out by the user device 100 illustrated in FIG. 1, for example. Further, method 670 may begin at block 601 while the user device 100 is outputting (e.g., via a speaker of the user interface 204 of the user device 100) a piece of media (e.g., a sound, such as a song).

At block 601, the method 670 may include turning on a display (e.g., of a user interface 204) of the user device 100. This may occur when a button on the user device 100 is engaged (e.g., by a user of the user device 100). After block 601, the method 670 may proceed to block 602.

At block 602, the method 670 may include starting a BLE scanning (e.g., via a BLE discovery using the first BLE transceiver 116 of the user device 100) to identify home devices. After block 602, the method 670 may proceed to block 603.

At block 603, the method 670 may include determining whether a home device was found by the BLE scanning of block 602. If a home device was not found, the method 670 may proceed to block 604. If a home device was found, the method 670 may proceed to block 605.

At block 604, the method 670 may include determining whether a display (e.g., of a user interface 204) of the user device 100 is turned off. If the display is turned off, the method 670 may proceed to block 613. If the display is not turned off, the method 670 may proceed to block 602.

At block 605, the method 670 may include starting UWB range measurement and motion monitoring (e.g., using the first UWB transceiver 114 and/or an IMU of the user device 100). After block 605, the method 670 may proceed to block 606.

At block 606, the method 670 may include determining whether the user device 100 is moving (e.g., based on one or more measurements from an IMU of the user device 100) by comparing a velocity of the user device 100 to a threshold velocity. If the velocity is greater than or equal to the threshold velocity, the method 670 may proceed to block 607. If the velocity is less than the threshold velocity, the method 670 may proceed to block 608.

At block 607, the method 670 may include setting a high UWB transmission frequency (e.g., for UWB communication between the first UWB transceiver 114 of the user device 100 and the second UWB transceiver 314 of the handoff device 310). In some embodiments, the high UWB transmission frequency may be between 8 Hz and 12 Hz (e.g., about 10 Hz). Implementing the high UWB transmission frequency may include inserting delays between transmissions of UWB signals (e.g., delays of about 0.1 seconds). UWB signals communicated between the first UWB transceiver 114 and the second UWB transceiver 314 may be used to determine a separation between the first UWB transceiver 114 and the second UWB transceiver 314. After block 607, the method 670 may proceed to block 609.

At block 608, the method 670 may include setting a low UWB transmission frequency (e.g., for UWB communication between the first UWB transceiver 114 of the user device 100 and the second UWB transceiver 314 of the handoff device 310). In some embodiments, the low UWB transmission frequency may be between 0.02 Hz and 0.08 Hz (e.g., about 0.05 Hz). Implementing the low UWB transmission frequency may include inserting delays between transmissions of UWB signals (e.g., delays of about 20 seconds). UWB signals communicated between the first UWB transceiver 114 and the second UWB transceiver 314 may be used to determine a separation between the first UWB transceiver 114 and the second UWB transceiver 314. After block 608, the method 670 may proceed to block 609.

At block 609, the method 670 may include comparing a separation between the user device 100 and the handoff device 310 (e.g., based on a separation between the first UWB transceiver 114 and the second UWB transceiver 314 determined using UWB signals) to a first range threshold (e.g., the first range threshold 502 illustrated and described with respect to FIG. 5A). If the separation is greater than or equal to the first range threshold, the method 670 may proceed to block 611. If the separation is less than the first range threshold, the method 670 may proceed to block 610.

At block 610, the method 670 may include performing a media handoff. Performing a media handoff may include transmitting a piece of media (e.g., a sound, a video, an image, etc.) from the user device 100 to the handoff device 310. Additionally or alternatively, performing a media handoff may include the user device 100 indicating (e.g., via a transmitted signal) to the handoff device 310 which piece of media (e.g., from a repository) is to be output. Still further, performing a media handoff may include the user device 100 transmitting a signal to the handoff device 310 that causes the handoff device 310 to output the piece of media. Yet further, after receiving the signal that causes the handoff device 310 to output the piece of media, the handoff device 310 may begin outputting the piece of media (e.g., via the user interface 304 of the handoff device 310). In addition, performing a media handoff may include the user device 100 (e.g., the user interface 204 of the user device 100) ceasing to output the piece of media. Further, in some embodiments, block 610 may include terminating the method 670.

At block 611, the method 670 may include determining whether the display of the user device 100 is presently powered off. If the display is powered off, the method 670 may proceed to block 612. If the display is not powered off, the method 670 may proceed to block 606.

At block 612, the method 670 may include comparing a time elapsed since the display of the user device 100 was last on (e.g., an amount of time elapsed since the display of the user device 100 was powered off) to a threshold duration. If the time elapsed is greater than or equal to the threshold duration, the method 670 may proceed to block 613. If the time elapsed is less than the threshold duration, the method 670 may proceed to block 606. The determination of block 612 may allow the user device 100 (e.g., executing method 670) to continue monitoring whether a media handoff is to be performed for a threshold duration after the display has been turned off (e.g., so as to avoid false negatives for some period of time after the display has been turned off).

At block 613, the method 670 may include closing all ranging activities. Closing all ranging activities may include ceasing BLE communications using the first BLE transceiver 116, ceasing UWB communications using the first UWB transceiver 114, ceasing GNSS monitoring using a GNSS interface of the user device 100, and/or ceasing motion monitoring using an IMU of the user device 100. Further, in some embodiments, block 613 may include terminating the method 670.

FIG. 6B illustrates a method 680, according to example embodiments. The method may be carried out by the user device 100 illustrated in FIG. 1, for example. Further, method 680 may begin at block 620 while the user device 100 is outputting (e.g., via a speaker of the user interface 204) a piece of media (e.g., a sound, such as a song).

At block 620, the method 680 may include turning on a display (e.g., of a user interface 204) of the user device 100. This may occur when a button on the user device 100 is engaged (e.g., by a user of the user device 100). After block 620, the method 680 may proceed to block 621.

At block 621, the method 680 may include starting a BLE scanning (e.g., via a BLE discovery using the first BLE transceiver 116 of the user device 100) to identify home devices (e.g., home handoff devices). After block 621, the method 680 may proceed to block 622.

At block 622, the method 680 may include determining whether a device at a predefined location (e.g., a home device) was found by the BLE scanning of block 621. If a home device was not found, the method 680 may proceed to block 623. If a home device was found, the method 680 may proceed to block 624.

At block 623, the method 680 may include determining whether a display (e.g., of a user interface 204) of the user device 100 is turned off. If the display is turned off, the method 680 may proceed to block 635. If the display is not turned off, the method 680 may proceed to block 621.

At block 624, the method 680 may include starting UWB range measurement and motion monitoring (e.g., using the first UWB transceiver 114 and/or an IMU of the user device 100). After block 624, the method 680 may proceed to block 625.

At block 625, the method 680 may include determining whether the user device 100 is moving (e.g., based on one or more measurements from an IMU of the user device 100) by comparing a velocity of the user device 100 to a threshold velocity. If the velocity is greater than or equal to the threshold velocity, the method 680 may proceed to block 626. If the velocity is less than the threshold velocity, the method 680 may proceed to block 627.

At block 626, the method 680 may include setting a high UWB transmission frequency (e.g., for UWB communication between the first UWB transceiver 114 of the user device 100 and the second UWB transceiver 314 of the handoff device 310). In some embodiments, the high UWB transmission frequency may be between 8 Hz and 12 Hz (e.g., about 10 Hz). Implementing the high UWB transmission frequency may include inserting delays between transmissions of UWB signals (e.g., delays of about 0.1 seconds). UWB signals communicated between the first UWB transceiver 114 and the second UWB transceiver 314 may be used to determine a separation between the first UWB transceiver 114 and the second UWB transceiver 314. After block 626, the method 680 may proceed to block 628.

At block 627, the method 680 may include setting a low UWB transmission frequency (e.g., for UWB communication between the first UWB transceiver 114 of the user device 100 and the second UWB transceiver 314 of the handoff device 310). In some embodiments, the low UWB transmission frequency may be between 0.02 Hz and 0.08 Hz (e.g., about 0.05 Hz). Implementing the low UWB transmission frequency may include inserting delays between transmissions of UWB signals (e.g., delays of about 20 seconds). UWB signals communicated between the first UWB transceiver 114 and the second UWB transceiver 314 may be used to determine a separation between the first UWB transceiver 114 and the second UWB transceiver 314. After block 627, the method 680 may proceed to block 628.

At block 628, the method 680 may include comparing a separation between the user device 100 and the handoff device 310 (e.g., based on a separation between the first UWB transceiver 114 and the second UWB transceiver 314 determined using UWB signals) to a first range threshold (e.g., the first range threshold 502 illustrated and described with respect to FIG. 5A). If the separation is greater than or equal to the first range threshold, the method 680 may proceed to block 630. If the separation is less than the first range threshold, the method 680 may proceed to block 629.

At block 629, the method 680 may include performing a media handoff. Performing a media handoff may include transmitting a piece of media (e.g., a sound, a video, an image, etc.) from the user device 100 to the handoff device 310. Additionally or alternatively, performing a media handoff may include the user device 100 indicating (e.g., via a transmitted signal) to the handoff device 310 which piece of media (e.g., from a repository) is to be output. Still further, performing a media handoff may include the user device 100 transmitting a signal to the handoff device 310 that causes the handoff device 310 to output the piece of media. Yet further, after receiving the signal that causes the handoff device 310 to output the piece of media, the handoff device 310 may begin outputting the piece of media (e.g., via the user interface 304 of the handoff device 310). In addition, performing a media handoff may include the user device 100 (e.g., the user interface 204 of the user device 100) ceasing to output the piece of media. Further, in some embodiments, block 635 may include terminating the method 680.

At block 630, the method 680 may include determining whether the user device 100 is pointed toward the handoff device 310. Such a determination may be made based on UWB signals (e.g., indicative of relative angle and relative position) communicated between the first UWB transceiver 114 and the second UWB transceiver 314. Additionally or alternatively, such a determination may be made based on measurements made by an IMU of the user device 100. Further, determining whether the user device 100 is pointed at the handoff device 310 may include determining whether one or more portions of the user device 100 (e.g., a top, a display, a side, etc.) are closer to the handoff device 310 than one or more other portions of the user device 100 (e.g., the bottom, the back, an opposite side, etc.). If it is determined that the user device 100 is pointed toward the handoff device 310, the method 680 may proceed to block 631. If it is determined that the user device 100 is not pointed toward the handoff device 310, the method 680 may proceed to block 633.

At block 631, the method 680 may include the user device 100 vibrating (or providing some other sort of indication, such as some other form of tactile/haptic indication or a displayed indication, that a user response is requested). Vibrating the user device 100 may include energizing a motor of the user device 100 that has an unevenly distributed weight attached to its shaft, thereby causing a vibration of the entire user device 100. After block 631, the method 680 may proceed to block 632.

At block 632, the method 680 may include determining whether a confirmation (e.g., from a user) was received within a prescribed period (e.g., 1 second, 2 seconds, 3 seconds, 4 seconds, 5 seconds, 6 seconds, 7 seconds, 8 seconds, 9 seconds, 10 seconds, etc.). The confirmation may include a button on the user device 100 being engaged or a certain gesture being traced out by the user device 100 (e.g., shaking the user device 100, rotating the user device 100, making a swiping motion with the user device 100, etc.). If a confirmation was received with the prescribed period, the method 680 may proceed to block 629. If a confirmation was not received within the prescribed period, the method 680 may proceed to block 633.

At block 633, the method 680 may include determining whether the display of the user device 100 is presently powered off. If the display is powered off, the method 680 may proceed to block 634. If the display is not powered off, the method 680 may proceed to block 625.

At block 634, the method 680 may include comparing a time elapsed since the display of the user device 100 was last on (e.g., an amount of time elapsed since the display of the user device 100 was powered off) to a threshold duration (e.g., about 1 seconds, about 2 seconds, about 3 seconds, about 4 seconds, about 5 seconds, about 6 seconds, about 7 seconds, about 8 seconds, about 9 seconds, or about 10 seconds). If the time elapsed is greater than or equal to the threshold duration, the method 680 may proceed to block 635. If the time elapsed is less than the threshold duration, the method 680 may proceed to block 625. The determination of block 634 may allow the user device 100 (e.g., executing method 680) to continue monitoring whether a media handoff is to be performed for a threshold duration after the display has been turned off (e.g., so as to avoid false negatives for some period of time after the display has been turned off).

At block 635, the method 680 may include closing all ranging activities. Closing all ranging activities may include ceasing BLE communications using the first BLE transceiver 116, ceasing UWB communications using the first UWB transceiver 114, ceasing GNSS monitoring using a GNSS interface of the user device 100, and/or ceasing motion monitoring using an IMU of the user device 100. Further, in some embodiments, block 635 may include terminating the method 680.

FIG. 6C illustrates a method 690, according to example embodiments. The method may be carried out by the user device 100 illustrated in FIG. 1, for example. Further, method 690 may begin at block 640 while the user device 100 is outputting (e.g., via a speaker of the user interface 204) a piece of media (e.g., a sound, such as a song).

At block 640, the method 690 may include turning off a display (e.g., of a user interface 204) of the user device 100. This may occur when a button on the user device 100 is engaged (e.g., by a user of the user device 100). Alternatively, in some embodiments, block 640 may simply represent the display being in a powered off state (rather than changing from a powered on to a powered off state). Regardless of how the display obtained the powered off state, after block 640, the method 690 may proceed to block 641.

At block 641, the method 690 may include determining whether the user device 100 is located at a predefined location (e.g., an “at-home” location, an “at-work” location, etc.). Determining whether the user device 100 is located at the predefined location may include determining whether a WIFI network to which the user device 100 is connected (e.g., via a WIFI interface) is a WIFI network associated with the predefined location (e.g., an home WIFI network or a work WIFI network). Additionally or alternatively, determining whether the user device 100 located at the predefined location may include determining whether a GNSS location (e.g., as measured by a GNSS interface of the user device 100) falls within a predefined geofence. If the user device 100 is located at the predefined location, the method 690 may proceed to block 643. If the user device 100 is not located at the predefined location, the method 690 may proceed to block 642.

At block 642, the method 690 may include the user device 100 performing default activities that the user device 100 ordinarily performs when a display is turned off. For example, if the user device 100 is a mobile phone, the default activities may include receiving data transmissions from a cellular tower and/or another mobile device and, if a text message or telephone call is received, turning a display on and/or playing a sound to notify a user. Further, in some embodiments, block 642 may include terminating the method 690.

At block 643, the method 690 may include the user device 100 initiating motion monitoring. Initiating motion monitoring may include repeatedly making measurements using an IMU of the user device 100. For example, an IMU of the user device 100 may intermittently measure motion data and transmit the motion data to a processor of the user device 100.

At block 644, the method 690 may include determining whether the user device 100 was moved (e.g., whether the user device 100 was picked up by a user). Determining whether the user device 100 was moved may include analyzing data captured during motion monitoring (e.g., as initiated in block 643). Additionally or alternatively, determining whether the user device 100 was moved may include monitoring a location of the user device 100 over time using a GNSS interface of the user device 100 and/or measuring a WIFI network to which the user device 100 connected. If the user device 100 was moved, the method 690 may proceed to block 645. If the user device 100 was not moved, the method 690 may proceed to block 643.

At block 645, the method 690 may include starting a BLE scanning (e.g., via a BLE discovery using the first BLE transceiver 116 of the user device 100) to identify home devices (e.g., home handoff devices). After block 645, the method 690 may proceed to block 646.

At block 646, the method 690 may include determining whether a home device was found by the BLE scanning of block 645. If a home device was not found, the method 690 may proceed to block 647. If a home device was found, the method 690 may proceed to block 648.

At block 647, the method 690 may include modifying a BLE measurement frequency based on motion of the user device 100. The motion of the user device 100 may be determined using an IMU of the user device 100, for example. Further, modifying the BLE measurement frequency may include modifying a frequency at which the user device 100 (e.g., the first BLE transceiver 116 of the user device 100) broadcasts BLE discovery signals. In some embodiments, the faster the user device 100 is moving (and, therefore, the faster the user device 100 is changing locations), the higher the BLE measurement frequency the user device 100 may use. After block 647, the method 690 may proceed to block 649.

At block 648, the method 690 may include starting UWB range measurement and motion monitoring (e.g., using the first UWB transceiver 114 and/or an IMU of the user device 100). After block 648, the method 690 may proceed to block 650.

At block 649, the method 690 may include comparing an amount of time (if any) that the user device 100 has been stationary to a threshold duration. The amount of time that the user device 100 has been stationary may be determined based on measurements made by an IMU of the user device 100. If the amount of time that the user device 100 has been stationary is greater than or equal to the threshold duration, the method 690 may proceed to block 640. If the amount of time that the user device 100 has been stationary is less than the threshold duration, the method 690 may proceed to block 645.

At block 650, the method 690 may include determining whether the user device 100 is moving (e.g., based on one or more measurements from an IMU of the user device 100) by comparing a velocity of the user device 100 to a threshold velocity. If the velocity is greater than or equal to the threshold velocity, the method 690 may proceed to block 651. If the velocity is less than the threshold velocity, the method 690 may proceed to block 652.

At block 651, the method 690 may include setting a high UWB transmission frequency (e.g., for UWB communication between the first UWB transceiver 114 of the user device 100 and the second UWB transceiver 314 of the handoff device 310). In some embodiments, the high UWB transmission frequency may be between 8 Hz and 12 Hz (e.g., about 10 Hz). Implementing the high UWB transmission frequency may include inserting delays between transmissions of UWB signals (e.g., delays of about 0.1 seconds). UWB signals communicated between the first UWB transceiver 114 and the second UWB transceiver 314 may be used to determine a separation between the first UWB transceiver 114 and the second UWB transceiver 314. After block 651, the method 690 may proceed to block 653.

At block 652, the method 690 may include setting a low UWB transmission frequency (e.g., for UWB communication between the first UWB transceiver 114 of the user device 100 and the second UWB transceiver 314 of the handoff device 310). In some embodiments, the low UWB transmission frequency may be between 0.02 Hz and 0.08 Hz (e.g., about 0.05 Hz). Implementing the low UWB transmission frequency may include inserting delays between transmissions of UWB signals (e.g., delays of about 20 seconds). UWB signals communicated between the first UWB transceiver 114 and the second UWB transceiver 314 may be used to determine a separation between the first UWB transceiver 114 and the second UWB transceiver 314. After block 652, the method 690 may proceed to block 653.

At block 653, the method 690 may include comparing a separation between the user device 100 and the handoff device 310 (e.g., based on a separation between the first UWB transceiver 114 and the second UWB transceiver 314 determined using UWB signals) to a first range threshold (e.g., the first range threshold 502 illustrated and described with respect to FIG. 5A). If the separation is greater than or equal to the first range threshold, the method 690 may proceed to block 655. If the separation is less than the first range threshold, the method 690 may proceed to block 654.

At block 654, the method 690 may include performing a media handoff. Performing a media handoff may include transmitting a piece of media (e.g., a sound, a video, an image, etc.) from the user device 100 to the handoff device 310. Additionally or alternatively, performing a media handoff may include the user device 100 indicating (e.g., via a transmitted signal) to the handoff device 310 which piece of media (e.g., from a repository) is to be output. Still further, performing a media handoff may include the user device 100 transmitting a signal to the handoff device 310 that causes the handoff device 310 to output the piece of media. Yet further, after receiving the signal that causes the handoff device 310 to output the piece of media, the handoff device 310 may begin outputting the piece of media (e.g., via the user interface 304 of the handoff device 310). In addition, performing a media handoff may include the user device 100 (e.g., the user interface 204 of the user device 100) ceasing to output the piece of media. Further, in some embodiments, block 654 may include terminating the method 690.

At block 655, the method 690 may include determining whether the user device 100 is pointed toward the handoff device 310. Such a determination may be made based on UWB signals (e.g., indicative of relative angle and relative position) communicated between the first UWB transceiver 114 and the second UWB transceiver 314. Additionally or alternatively, such a determination may be made based on measurements made by an IMU of the user device 100. Further, determining whether the user device 100 is pointed at the handoff device 310 may include determining whether one or more portions of the user device 100 (e.g., a top, a display, a side, etc.) are closer to the handoff device 310 than one or more other portions of the user device 100 (e.g., the bottom, the back, an opposite side, etc.). If it is determined that the user device 100 is pointed toward the handoff device 310, the method 690 may proceed to block 656. If it is determined that the user device 100 is not pointed toward the handoff device 310, the method 690 may proceed to block 661.

At block 656, the method 690 may include the user device 100 vibrating (or providing some other sort of indication, such as some other form of tactile/haptic indication or a displayed indication, that a user response is requested). Vibrating the user device 100 may include energizing a motor of the user device 100 that has an unevenly distributed weight attached to its shaft, thereby causing a vibration of the entire user device 100. After block 656, the method 690 may proceed to block 657.

At block 657, the method 690 may include comparing how long the user device 100 has been pointed toward the handoff device 310 to a threshold duration. If the user device 100 has been pointed at the handoff device 310 for a length of time that is greater than or equal to the threshold duration, the method 690 may proceed to block 658. If the user device 100 has been pointed at the handoff device 310 for a length of time that is less than the threshold duration, the method 690 may proceed to block 659.

At block 658, the method 690 may include determining whether a confirmation (e.g., from a user) was received within a prescribed period (e.g., 1 second, 2 seconds, 3 seconds, 4 seconds, 5 seconds, 6 seconds, 7 seconds, 8 seconds, 9 seconds, 10 seconds, etc.). The confirmation may include a button on the user device 100 being engaged or a certain gesture being traced out by the user device 100 (e.g., shaking the user device 100, rotating the user device 100, making a swiping motion with the user device 100, etc.). If a confirmation was received with the prescribed period, the method 690 may proceed to block 654. If a confirmation was not received within the prescribed period, the method 690 may proceed to block 661.

At block 659, the method 690 may include the user device 100 displaying a notification (e.g., on a display of the user interface 204 of the user device 100). The notification may instruct the user to perform, at the user's decision, one of two tasks. The two tasks may include providing confirmation of a media handoff or orienting the user device 100 away from the handoff device 310. After block 659, the method 690 may proceed to block 658.

At block 660, the method 690 may include determining whether the user device 100 is located at a predefined location (e.g., an “at-home” location, an “at-work” location, etc.). Determining whether the user device 100 is located at the predefined location may include determining whether a WIFI network to which the user device 100 is connected (e.g., via a WIFI interface) is a WIFI network associated with the predefined location (e.g., an home WIFI network or a work WIFI network). Additionally or alternatively, determining whether the user device 100 located at the predefined location may include determining whether a GNSS location (e.g., as measured by a GNSS interface of the user device 100) falls within geographic boundaries representing the predefined location (e.g., a predefined geofence). If the user device 100 is located at the predefined location, the method 690 may proceed to block 650. If the user device 100 is not located at the predefined location, the method 690 may proceed to block 663.

At block 661, the method 690 may include determining whether the user device 100 is moving (e.g., based on one or more measurements from an IMU of the user device 100) by comparing a velocity of the user device 100 to a threshold velocity. If the velocity is greater than or equal to the threshold velocity (i.e., the user device 100 is moving), the method 690 may proceed to block 660. If the velocity is less than the threshold velocity (i.e., the user device 100 is not moving), the method 690 may proceed to block 662.

At block 662, the method 690 may include comparing the time since the user device 100 last moved to a threshold duration. Determining the time since the user device 100 last moved may include analyzing data (e.g., time stamps) measured by an IMU of the user device 100. If the time since the user device 100 last moved is greater than or equal to the threshold duration, the method 690 may proceed to block 663. If the time since the user device 100 last moved is less than the threshold duration, the method 690 may proceed to block 650.

At block 663, the method 690 may include closing all ranging activities. Closing all ranging activities may include ceasing BLE communications using the first BLE transceiver 116, ceasing UWB communications using the first UWB transceiver 114, ceasing GNSS monitoring using a GNSS interface of the user device 100, and/or ceasing motion monitoring using an IMU of the user device 100. After block 663, the method 690 may proceed to block 640.

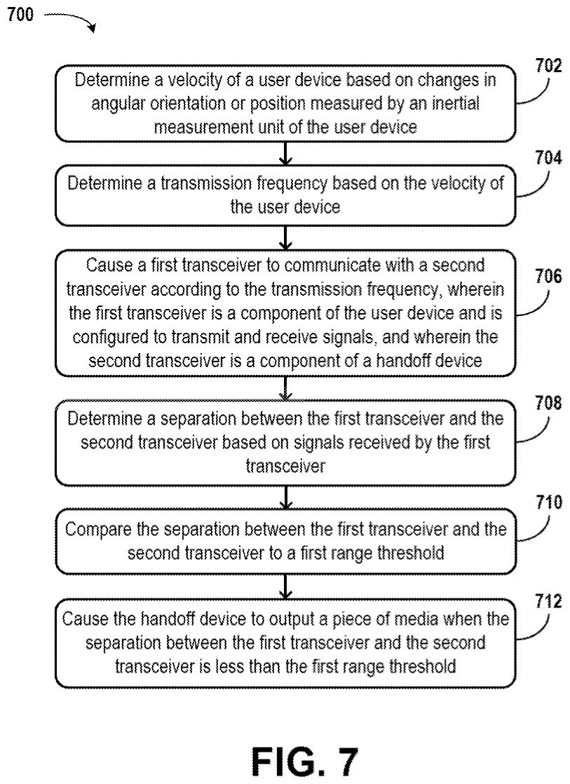

FIG. 7 is a flowchart diagram of a method 700, according to example embodiments. In some embodiments, the method 700 may be performed by the user device 100 shown and described with reference to FIGS. 1, 3, 4, 5A, 5B, and 5C.

At block 702, the method 700 may include determining a velocity of a user device 100 based on changes in angular orientation or position measured by an IMU of the user device 100.

At block 704, the method 700 may include determining a transmission frequency based on the velocity of the user device. In some embodiments, block 704 may be repeated at regular predefined intervals (e.g., to repeatedly monitor the velocity of the user device 100). For example, the velocity of the user device 100 (e.g., as repeatedly determined based on UWB signals) may be compared to a velocity threshold at a predefined interval of between about 0.2 seconds and about 0.8 seconds (e.g., 0.5 seconds)

At block 706, the method 700 may include causing a first transceiver to communicate with a second transceiver according to the transmission frequency, wherein the first transceiver is a component of the user device 100 and is configured to transmit and receive signals, and wherein the second transceiver is a component of a handoff device 310.

At block 708, the method 700 may include determining a separation between the first transceiver and the second transceiver based on signals received by the first transceiver.

At block 710, the method 700 may include comparing the separation between the first transceiver and the second transceiver to a first range threshold.

At block 712, the method 700 may include causing the handoff device 310 to output a piece of media when the separation between the first transceiver and the second transceiver is less than the first range threshold.

### III. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A device comprising:
a first transceiver configured to transmit and receive signals to communicate with a second transceiver of a handoff device, wherein the signals are indicative of an orientation and a position of the first transceiver relative to the second transceiver;
an inertial measurement unit configured to measure changes in angular orientation or position of the device;
a memory, wherein the memory stores a first set of instructions; and
a processor communicatively coupled to the first transceiver, the inertial measurement unit, and the memory, wherein the processor is configured to execute the first set of instructions to:
determine a velocity of the device based on the changes in angular orientation or position measured by the inertial measurement unit;
determine a transmission frequency based on the velocity of the device;
cause the first transceiver to communicate with the second transceiver according to the transmission frequency;
determine a separation between the first transceiver and the second transceiver based on signals received by the first transceiver;
compare the separation between the first transceiver and the second transceiver to a first range threshold; and
cause the handoff device to output a piece of media when the separation between the first transceiver and the second transceiver is less than the first range threshold.

2. The device of claim 1, further comprising a user interface configured to output the piece of media,
wherein the processor is communicatively coupled to the user interface,
wherein the memory further stores a second set of instructions,
wherein the processor is further configured to execute the second set of instructions to cause the user interface to output the piece of media, and
wherein the processor is further configured to execute the first set of instructions when the user interface is outputting the piece of media.

3. The device of claim 1,
wherein the piece of media comprises audio or one or more images,
wherein the handoff device comprises a television, a speaker, a smart-home hub, a desktop computer, or a tablet, and
wherein the device is a watch, a wristband, a mobile phone, a tablet, or a remote control.

4. (canceled)

5. (canceled)

6. The device of claim 1, further comprising a first BLUETOOTH Low Energy (BLE) transceiver configured to communicate with a second BLE transceiver of the handoff device to discover the handoff device,
wherein the processor is communicatively coupled to the first BLE transceiver, and
wherein the processor is further configured to execute the first set of instructions to:
cause the first BLE transceiver to transmit one or more BLE signals to perform a device discovery; and
identify, based on one or more BLE signals received by the first BLE transceiver, the handoff device.

7. The device of claim 1, wherein the processor is further configured to execute the first set of instructions to determine whether the device is located at a predefined location, and wherein the predefined location corresponds to an at-home location or an at-work location.

8. (canceled)

9. The device of claim 7, further comprising a WIFI interface,
wherein the processor is communicatively coupled to the WIFI interface, and
wherein determining whether the device is located at the predefined location comprises identifying a WIFI network to which the device is connected.

10. The device of claim 7, further comprising a global navigation satellite system (GNSS) interface,
wherein the processor is communicatively coupled to the GNSS interface, and
wherein determining whether the device is located at the predefined location comprises:
determining GNSS coordinates of the device based on the GNSS interface; and
comparing the GNSS coordinates of the device to geographic boundaries representing the predefined location.

11. The device of claim 1, wherein the transmission frequency is determined by comparing the velocity of the device to a velocity threshold repeatedly based on a predefined interval, and wherein the predefined interval is about 0.5 seconds.

12. The device of claim 1, wherein the transmission frequency is determined by comparing the velocity of the device to a velocity threshold, wherein the transmission frequency is determined to be about 0.05 Hz when the velocity of the device is less than the velocity threshold, and wherein the transmission frequency is determined to be about 10 Hz when the velocity of the device is greater than or equal to the velocity threshold.

13. The device of claim 1, wherein the memory further stores a third set of instructions, and wherein the processor is further configured to execute the third set of instructions to determine whether a display of the device is currently turned on.

14. The device of claim 13, wherein the processor is further configured to, when the device is currently turned on, execute the first set of instructions to:
compare the separation between the first transceiver and the second transceiver to a second range threshold;
cause, when the separation between the first transceiver and the second transceiver is greater than or equal to the first range threshold and less than the second range threshold, a prompt to be displayed on the display of the device, wherein the prompt requests confirmation of whether to cause the handoff device to output the piece of media;
receive, based on the prompt, an indication that the handoff device is to output the piece of media; and
cause, based on the received indication, the handoff device to output the piece of media.

15. The device of claim 13,
wherein the processor is further configured to execute the third set of instructions to:
determine, when the display of the device is currently turned off, an amount of time elapsed since the display of the device was last on; and
compare the amount of time elapsed since the display of the device was last on to a threshold duration, and
wherein the processor is configured to execute the first set of instructions when the amount of time elapsed since the display of the device was last on is less than the threshold duration.

16. (canceled)

17. The device of claim 13,
wherein the memory further stores a fourth set of instructions, and
wherein, when the display of the device is currently turned off, the processor is further configured to execute the fourth set of instructions to:
determine whether the device has moved from one location to another based on the changes in angular orientation or position measured by the inertial measurement unit; and
execute, when the device is moved from one location to another, the first set of instructions.

18. The device of claim 13,
wherein the memory further stores a fifth set of instructions, and
wherein, when the display of the device is currently turned off, the processor is further configured to execute the fifth set of instructions to:
cause the first transceiver to communicate with the second transceiver;
determine whether the device is pointed at the handoff device based on signals received by the first transceiver; and
cause the handoff device to output the piece of media when the device is pointed at the handoff device.

19. The device of claim 18,
wherein the processor is further configured to execute the fifth set of instructions to:
determine whether a gesture is traced out by the device based on signals received by the first transceiver; and
in response to a gesture being traced out by the device, determine whether the traced out gesture corresponds to a confirmation gesture indicating that the piece of media is to be output by the handoff device, and
wherein the handoff device is caused to output the piece of media when the device is pointed at the handoff device and the confirmation gesture is traced out.

20. The device of claim 19, wherein the processor is further configured to execute the fifth set of instructions to cause the device to provide haptic feedback before determining whether the gesture is traced out by the device based on signals received by the first transceiver.

21. (canceled)

22. The device of claim 1, wherein:
the first transceiver comprises an ultra-wideband (UWB) transceiver;
the second transceiver comprises a UWB transceiver;
the first transceiver is configured to transmit and receive UWB signals to communicate with the second transceiver; and
the UWB signals are indicative of the orientation and the position of the first transceiver relative to the second transceiver; or
wherein:
the first transceiver comprises a WIFI transceiver;
the second transceiver comprises a WIFI transceiver;
the first transceiver is configured to transmit and receive WIFI signals to communicate with the second transceiver; and
the WIFI signals are indicative of the orientation and the position of the first transceiver relative to the second transceiver; or
wherein:
the first transceiver comprises a BLUETOOTH transceiver;
the second transceiver comprises a BLUETOOTH transceiver;
the first transceiver is configured to transmit and receive BLUETOOTH signals to communicate with the second transceiver; and
the BLUETOOTH signals are indicative of the orientation and the position of the first transceiver relative to the second transceiver.

23. (canceled)

24. (canceled)

25. A system comprising:
a handoff device comprising a second transceiver; and
a user device comprising:
a first transceiver configured to transmit and receive signals to communicate with the second transceiver, wherein the signals are indicative of an orientation and a position of the first transceiver relative to the second transceiver;
an inertial measurement unit configured to measure changes in angular orientation or position of the user device;
a memory, wherein the memory stores a first set of instructions; and
a processor communicatively coupled to the first transceiver, the inertial measurement unit, and the memory, wherein the processor is configured to execute the first set of instructions to:
determine a velocity of the user device based on the changes in angular orientation or position measured by the inertial measurement unit;
determine a transmission frequency based on the velocity of the user device;
cause the first transceiver to communicate with the second transceiver according to the transmission frequency;
determine a separation between the first transceiver and the second transceiver based on signals received by the first transceiver;
compare the separation between the first transceiver and the second transceiver to a first range threshold; and
cause the handoff device to output a piece of media when the separation between the first transceiver and the second transceiver is less than the first range threshold.

26. A method comprising:
determining a velocity of a user device based on changes in angular orientation or position measured by an inertial measurement unit of the user device;
determining a transmission frequency based on the velocity of the user device;
causing a first transceiver to communicate with a second transceiver according to the transmission frequency, wherein the first transceiver is a component of the user device and is configured to transmit and receive signals, and wherein the second transceiver is a component of a handoff device;
determining a separation between the first transceiver and the second transceiver based on signals received by the first transceiver;
comparing the separation between the first transceiver and the second transceiver to a first range threshold; and
causing the handoff device to output a piece of media when the separation between the first transceiver and the second transceiver is less than the first range threshold.

27. A non-transitory, computer-readable medium having stored therein instructions executable by one or more processors to perform the method of claim 26.
